(19) United States
(12) Patent Application Publication
(10) Pub. No.: US 2015/0319063 A1
(43) Pub. Date: Nov. 5, 2015

(54) DYNAMICALLY ASSOCIATING A DATACENTER WITH A NETWORK DEVICE

(71) Applicant: Jive Communications, Inc., Orem, UT (US)

(72) Inventor: Theo Peter Zourzouvillys, Orem, UT (US)

(21) Appl. No.: 14/335,103

(22) Filed: Jul. 18, 2014

Related U.S. Application Data
(60) Provisional application No. 61/986,747, filed on Apr. 30, 2014.

(51) Int. Cl. H04L 12/26; H04M 7/00; H04L 29/06

(52) U.S. Cl. CPC H04L 43/0811; H04L 65/1006; H04M 7/006

(57) ABSTRACT

The present application details exemplary methods and systems for monitoring and analyzing network characteristics between the network device and a plurality of datacenters. The network device dynamically maps to the datacenter that associates with a superior available network connection. Further, the network device may dynamically map to different datacenters based on various network characteristics between the network device and available connections between each datacenter.

### CROSS REFERENCE TO RELATED APPLICATIONS

This application claims priority to and the benefit of U.S. Provisional Application No. 61/986,747 filed Apr. 30, 2014, entitled “Dynamically Associating a Datacenter with a Network Device.” The entire contents of the foregoing application are hereby incorporated by reference in their entirety.

### BACKGROUND

1. Technical Field

One or more embodiments disclosed herein relate generally to facilitating communications over a network. More specifically, one or more embodiments disclosed herein relate to dynamically associating an electronic communications device with a datacenter.

2. Background and Relevant Art

Advances in electronic communications technologies have interconnected people and allowed for better communication than ever before. To illustrate, users traditionally relied on a public switched telephone network (“PSTN”) to speak with other users in real-time. Now, users may communicate using network or Internet-based communication systems. One such network-based system is an internet protocol (“IP”) telephone system, such as a voice over IP (“VoIP”) communication system.

Conventional VoIP systems commonly rely on a primary datacenter/backup datacenter general architecture to provide VoIP services for each VoIP device in the system. The backup datacenter generally is a duplicate of the primary datacenter and provides the same functionality as the primary datacenter. The purpose of the backup datacenter is to provide an available option to keep the VoIP system operating in the event the primary datacenter fails (e.g., network failure, hardware failure, datacenter maintenance).

A number of disadvantages exist with respect to conventional VoIP systems. For example, conventional VoIP systems include a large amount of redundancy, overhead, and inefficiency in maintaining duplicate backup datacenters. In particular, although infrequently in use, a backup datacenter requires about the same amount of resources as the primary datacenter. For example, a backup datacenter typically mirrors the primary datacenter, and thus includes a large amount of hardware, other equipment, and logistical support, all of which remain generally unused. Therefore, the efficiency at which many conventional VoIP systems utilize resources is low.

In addition to low utilization efficiency, traditional VoIP systems commonly experience bottlenecking issues at the primary datacenter when network loads increase. For example, as the number of network devices using the VoIP system increases, the limited resources of the primary datacenter may become overloaded. Thus, the quality of service available to customers is reduced. In addition, as the number of users and VoIP devices in the VoIP system increase, scalability requires that the primary datacenter physically increase in size and resources, which adds substantial costs. Often, the capabilities of the redundant backup datacenter must also be increased.

The primary datacenter/backup datacenter model may also increase the possibility of system failure. For example, having a single datacenter increases the susceptibility to malicious attacks as a hacker wanting to disrupt a VoIP system need only to target the primary datacenter. Similarly, accidents, such as a power failure, may cripple the VoIP system until operations can be shifted to the backup datacenter. As often is the case, customers on a call during an outage will lose the call completely and often have to wait for service to be restored as the VoIP service provider shifts the VoIP system to the backup datacenter.

In addition, for many conventional VoIP systems, switching from the primary datacenter to a backup datacenter is a complicated process, and often requires substantial manual user intervention. For example, each VoIP device must be re-registered with new addresses corresponding to the backup datacenter. Current calls also need to be reestablished via the backup datacenter. In addition, user settings, voice-messages, etc., for each VoIP device needs to be moved from the primary datacenter to the backup datacenter. Moreover, while serving as the acting primary datacenter, the backup datacenter is susceptible to many of the same disadvantages discussed above.

Accordingly, there are a number of considerations to be made in improving the convenience, access, and systems associated with network-based communication systems.

### BRIEF SUMMARY

Embodiments disclosed herein provide benefits and/or solve one or more of the foregoing or other problems in the art with systems and methods that dynamically map a network device with a datacenter from among a plurality of datacenters. In particular, example embodiments disclosed herein disclose a network device configured to dynamically map to a datacenter based on one or more network characteristics. Dynamically mapping a network device to a datacenter can improve the overall reliability and quality of the communications system.

In one or more example embodiments, a network device can dynamically monitor network characteristics and analyze network factors between the network device and multiple datacenters to determine the best available connection to one of the multiple datacenters. For example, the network device may analyze one or more network factors such as quality of network connection, the shortest response time, the reliability of the communication path, the amount of network traffic, the geographic distance, the number of hops, or any combination thereof, to determine a connectivity metric. The network device may then map to the datacenter having the highest connectivity metric.

In another example embodiment, a datacenter is disclosed that gathers information from one or more network devices and optimizes the VoIP system based on the gathered information. For example, a datacenter may gather network characteristic information from the one or more network devices and/or the datacenters to which each of the one or more network devices is connected. The datacenter may use the network characteristic information to perform adjustments to the VoIP systems (e.g., change to which datacenter one or more network devices are mapped). These adjustments may help optimize the use of datacenter resources and ensure reliable connections between a datacenter and the network devices. Accordingly, the principles disclosed herein provide methods and systems to reduce system redundancy, overhead, and inefficiency in a network-based unified communications system, such as a VoIP system.

Additional features and advantages disclosed herein will be set forth in the description which follows, and in part will be obvious from the description, or may be learned by the practice of such exemplary embodiments. The features and advantages of such embodiments may be realized and obtained by means of the instruments and combinations particularly pointed out in the appended claims. These and other features will become more fully apparent from the following description and appended claims, or may be learned by the practice of such exemplary embodiments as set forth hereinafter.

### BRIEF DESCRIPTION OF THE DRAWINGS

In order to describe the manner in which the above recited and other advantages and features of the invention can be obtained, a more particular description of one or more embodiments briefly described above will be rendered by reference to specific embodiments thereof that are illustrated in the appended drawings. It should be noted that the figures are not drawn to scale, and that elements of similar structure or function are generally represented by like reference numerals for illustrative purposes throughout the figures. Understanding that these drawings depict only typical embodiments of the invention and are not therefore to be considered limiting of its scope, the invention will be described and explained with additional specificity and detail through the use of the accompanying drawings in which:

FIG. 1 illustrates a network-based communications system in accordance with one or more embodiments disclosed herein;

FIG. 2 illustrates a network-based VoIP communication system in accordance with one or more embodiments disclosed herein;

FIG. 3 illustrates an map where the VoIP communication system of FIG. 2 may be utilized in accordance with one or more embodiments disclosed herein;

FIG. 4 illustrates a sequence-flow diagram illustrating interactions between the network device, the first datacenter, and the second datacenter in the VoIP communication system of FIG. 2 in accordance with one or more embodiments disclosed herein;

FIG. 5 illustrates an exemplary method of dynamically associating a network device with a datacenter in accordance with one or more embodiments disclosed herein;

FIG. 6 illustrates another exemplary method of dynamically associating a network device with a datacenter in accordance with one or more embodiments disclosed herein;

FIG. 7 illustrates an exemplary method of monitoring and maintaining a dynamic communication system in accordance with one or more embodiments disclosed herein;

FIG. 8 illustrates a block diagram of an exemplary computing device according to the principles described herein; and

FIG. 9 illustrates an example network environment of a VoIP communication system according to the principles described herein.

### DETAILED DESCRIPTION

Embodiments disclosed herein provide benefits and/or solve one or more of the abovementioned problems or other problems in the art with improving user communication in a network-based communication system. In particular, one or more example embodiments include a system that allows a network device to dynamically map to various datacenters based on determining the optimal available connection to connect to a datacenter. Thus, unlike conventional Internet Protocol (“IP”) communication systems described above, where a network device is statically associated with a single datacenter, embodiments herein disclose a system that allows a network device to dynamically remap to another datacenter based on determining that another available datacenter connection is superior to the connection the network device is currently using.

For example, the system can include a network device that is mapped to a first datacenter. The system can determine that an available connection to a second datacenter is superior to the current connection with the mapped datacenter. Upon making the determination that the available connection is superior, the network device can dynamically map to the second datacenter (e.g., remap the from the first datacenter to the second datacenter). In one or more embodiments, the network device can perform the dynamic mapping process during a communication session.

In one or more embodiments, the system can monitor connection factors associated with connections, or available connections, to one or more datacenters in order to identify network characteristics of each connection. In addition, the system can analyze the network characteristics to determine a connectivity metric for each available connection associated with a data center. The system can use the connectivity metrics for each connection to determine an optimal connection (e.g., the fastest, most stable, highest quality connection) available to the network device. Furthermore, the system can cause the network device to remap to a different datacenter based on determining the optimal connection.

In order to determine a connectivity metric, one or more embodiments of the system may employ an algorithm to identify an optimal available connection based on current network characteristics. The algorithm may assign higher or lower weights to each connection factor, as will be further described below. In one or more embodiments disclosed herein, the algorithm may be adjusted based on overall network status, datacenter usage, etc.

Furthermore, one or more embodiments of the system can map network devices to evenly distribute network and processing loads across datacenters, or to shift network and processing loads away from a datacenter with a problem. In this manner, multiple datacenters work in tandem to provide a consistent, efficient, and stable communication system while, at the same time, also providing backup protection to each other. As such, the systems described herein greatly reduce the duplicative waste and inefficacies of the traditional systems described above.

In addition to dynamically mapping a network device to the optimal datacenter connection, one or more embodiments disclosed herein can optimize network-based communication systems by ensuring connection reliability between network devices and datacenters. For example, the system can cause a network device to send to one or more datacenters network information, including the datacenter to which the network device has a connection, as well as connectivity metrics measured at the network device.

The datacenter may use the network information to determine when network loads require rebalancing. Further, the datacenter may detect potential connection losses based on the network information in one network device and prevent similar connection losses in other network devices. Accordingly, the datacenter may send general network information to a network device and the network device may use the general network information (e.g., within a connectivity metric algorithm) when determining to which datacenter to connect.

In addition to the above described features and benefits, example embodiments of the network-based communication system reduce redundancy, overhead, and inefficiency in the system. For instance, the methods and systems disclosed herein efficiently employ multiple datacenters without redundantly duplicating resources. For example, in one or more embodiments, half of the network devices may be connected to a first datacenter, and the second half may be connected to a second datacenter. In this embodiment, both datacenters are being employed and the network load is balanced between the datacenters.

In addition, the methods and systems disclosed herein reduce bottlenecking and provide increased quality and service through dynamic distribution of communication services. For example, when a datacenter approaches full network or processing capacity, the system may detect slowdowns in performance and/or a reduction in the network connection quality. The reduction in connection quality and performance at the network device may be a sign to consider switching to another datacenter. In another instance, the datacenter may notify one or more network devices regarding the datacenter's available resources and the network device may use this as a connection factor in determining to which datacenter to map.

Furthermore, the system and methods described herein allow system scalability to occur without requiring extensive upgrades or logistical changes. For example, as the number of users increase, an additional datacenter may be constructed. Once the new datacenter is online, the network devices may then dynamically connect to the new datacenter when a network device determines that the new datacenter associates with the optimal available connection. In contrast, in conventional systems, increasing scalability often requires increasing the capacity of the primary datacenter as well as the capacity of backup datacenters, which at least doubles the costs when expanding a network.

Moreover, the system and methods herein allow for minimizing or eliminating the need of manually transitioning network devices from a failed primary datacenter to a backup datacenters, thus reducing the potential for system downtime. For example, a network device may map to a different datacenter when network characteristics with the existing datacenter begin to deteriorate.

In addition, when remapping occurs, the user does not detect that the network device has changed from one datacenter to another, even when the user is actively using the network device. In other words, a user on a VoIP communication session may not detect that a datacenter connection was switched because the network device may seamlessly transition to another datacenter connection without causing a noticeable disruption in communication service.

Additional advantages and benefits of the system will become apparent in view of the below description. In particular, one or more embodiments of the system will be described below with reference to one or more figures. In addition, the following definitions of terms will be used to describe one or more features of the system.

As used herein, the term “datacenter” refers generally to one or more computing devices that facilitate communication sessions between network devices. In some configurations, a datacenter refers to a facility that houses computer systems and associated components, such as telecommunications and storage systems. For example, one of skill on the art will appreciate that a datacenter may comprise a single computing device that facilitates communication between two network devices, or that a datacenter may comprise a building housing computers, servers, and other components facilitating communication for thousands of network devices. Further, a datacenter may be an outbound proxy.

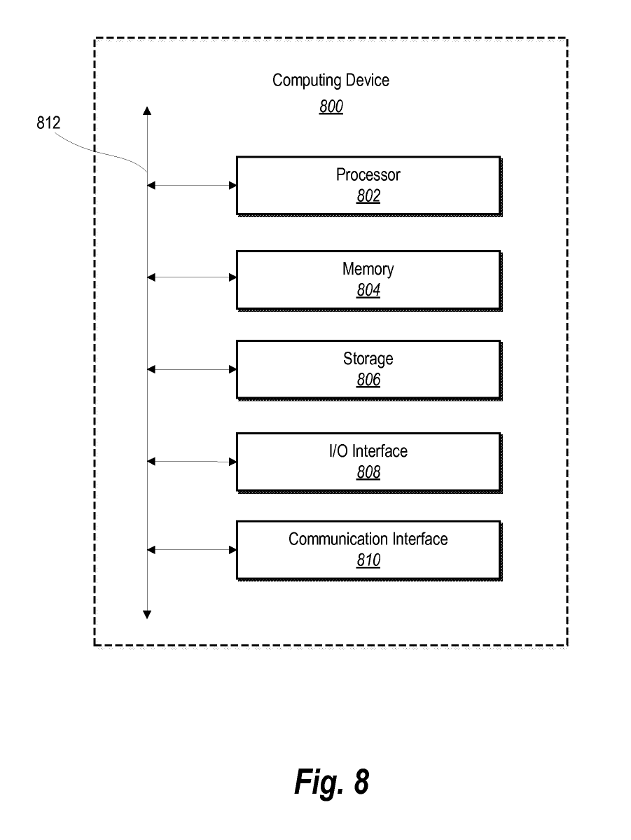

In addition, the terms “device,” “network device,” or “VoIP device” as used herein refer generally to a computing device that is used to participate in a communication session. A network device can communicate with a datacenter and networks with other network devices. A variety of network devices may employ VoIP technology, such as personal computers, handheld devices, mobile phones, smartphones, and other electronic access devices. As an example, a network device may be a dedicated VoIP device or soft VoIP device. Dedicated and soft devices are described in greater detail below in connection with FIG. 8.

As used herein, the terms “session,” “communication session,” or “multimedia communication session” refers generally to a communication interaction between users that occurs over an IP network. For example a communication session may include voice or video calling, video conferencing, streaming multimedia distribution, instant messaging, presence information sharing, file transferring, faxing over IP, and online gaming. For instance, a session may be part of the session initiation protocol (“SIP”), which is a signaling communications protocol commonly used in network-based communication systems. Likewise, a session may refer to a communication session using other protocols common to IP peer communications.

As used herein, the terms “connection” and “network connection” refer generally to an established communication link between at least two computing devices. For instance, two or more network devices connect to, or with, each other when each network device acknowledges the connection with the other network device(s). For example, as further described below, a connection between a network device and a datacenter may occur when the network device is mapped to and registers with the datacenter. A connection can include one or more types of connections, such as a switched circuit connection, a virtual circuit connection, or a network connection. For example, a network connection between multiple network devices occurs over a network, such as the Internet, and data sent between the multiple network devices via the network connection may employ various network paths.

The term “available connection” as used herein generally refers to a potential connection between at least two network devices. Upon establishing a communication link, an available connection may become a connection. For example, a network device may have one or more available connections with multiple datacenters. Further, the term “available datacenter connection” may refer to an available connection between a network device and one or more datacenters to which the network device is not currently connected. Upon mapping to and registering with a datacenter, the network device establishes a connection with the datacenter. While connected to the datacenter, the network device may still monitor available connections with the remaining datacenters (e.g., available datacenter connections) to which the network device is not connected.

As used herein, the term “connection factor(s)” generally refers to properties of a network. In general, a connection factor refers to a network property that may be monitored, measured, and/or reported. For example, a network device may measure one or more connection factors for a connection, or an available connection, between the network device and a datacenter. For instance, the network device may measure one or more of the following connection factors for an available connection between the network device and the datacenter, including, but not limited to, the quality of the network connection, the reliability of the communication path, the response time, the amount of network traffic, the number of retransmissions, the number of dropped packets, the geographic distance, and the number of hops between the two network devices.

The term “network characteristic” refers generally to an identifiable value or data type associated with a connection factor. For example, a network characteristic may be a value representing a current state of a connection factor. For instance, if a connection factor measures the number of hops between two network devices for a connection or available connection, the network characteristic may be the reported number of hops between the two network devices.

The term “connectivity metric,” as used herein, generally refers to a result determined from performing an analysis on one or more network characteristics. In particular, a connectivity metric may be the result of analyzing one or more network characteristics. For example, a network device may employ an algorithm that analyzes multiple network characteristics to determine a connectivity metric. Connectivity metrics may be compared, rated, or ranked with each other. Comparing, rating, or ranking connectivity metrics for available networks may determine the optimal available connection. In addition, a connection may be compared to an available connection by comparing their respective connectivity metric to each other.

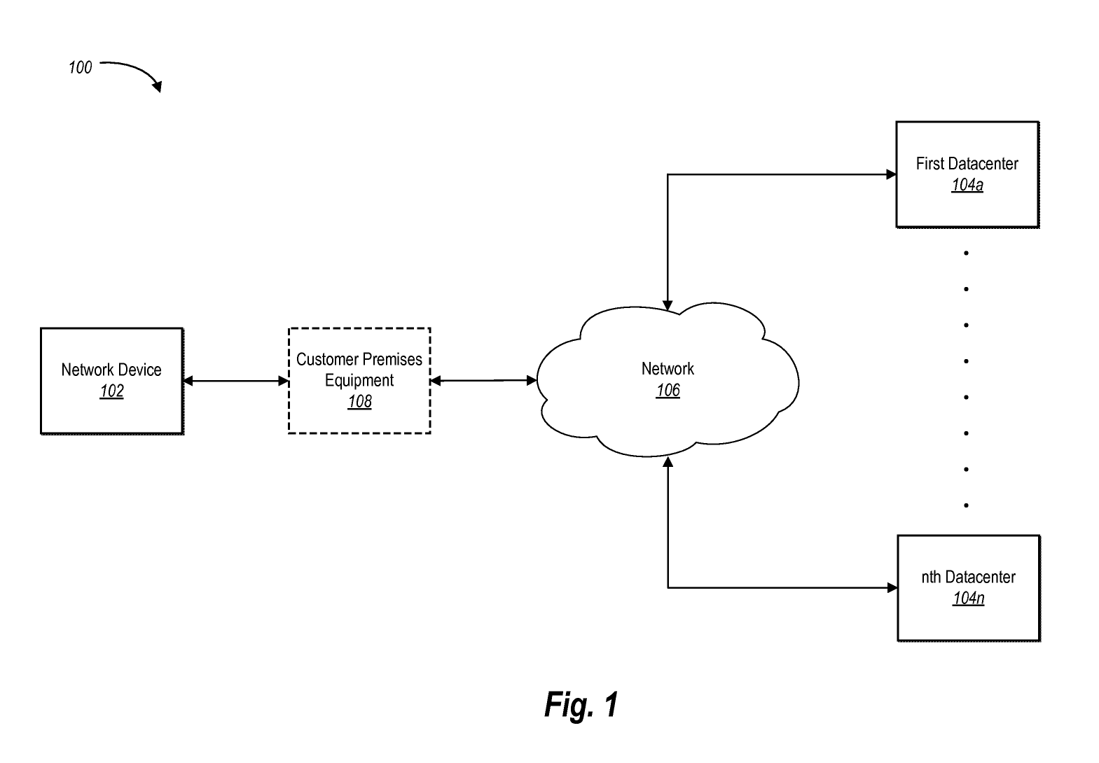

Although the disclosure discusses VoIP telephone network-based systems, it should be understood that the principles, systems, and methods disclosed herein may also be effectively used in other types of packet-based IP communication networks and unified (e.g., real-time) communication systems. For instance, the principles described may be used for sending faxes, text messages, and voice-messages over a network-based communication system. FIG. 1, for example, illustrates a network-based communications system 100 (or simply “system 100”) in accordance with one or more embodiments disclosed herein. An overview of the system 100 will be described next in relation to FIG. 1. Thereafter, a more detailed description of the components and processes of the system 100 will be described in relation to the remaining figures.

As illustrated by FIG. 1, the system 100 may include, but is not limited to, a network device 102, a first datacenter 104a, and an nth datacenter 104n. As shown, datacenters 104a-n may be present in the system 100. Similarly, while not illustrated, the system 100 may include multiple devices. For example, the system 100 may include almost any number of network devices 102 and/or datacenters 104.

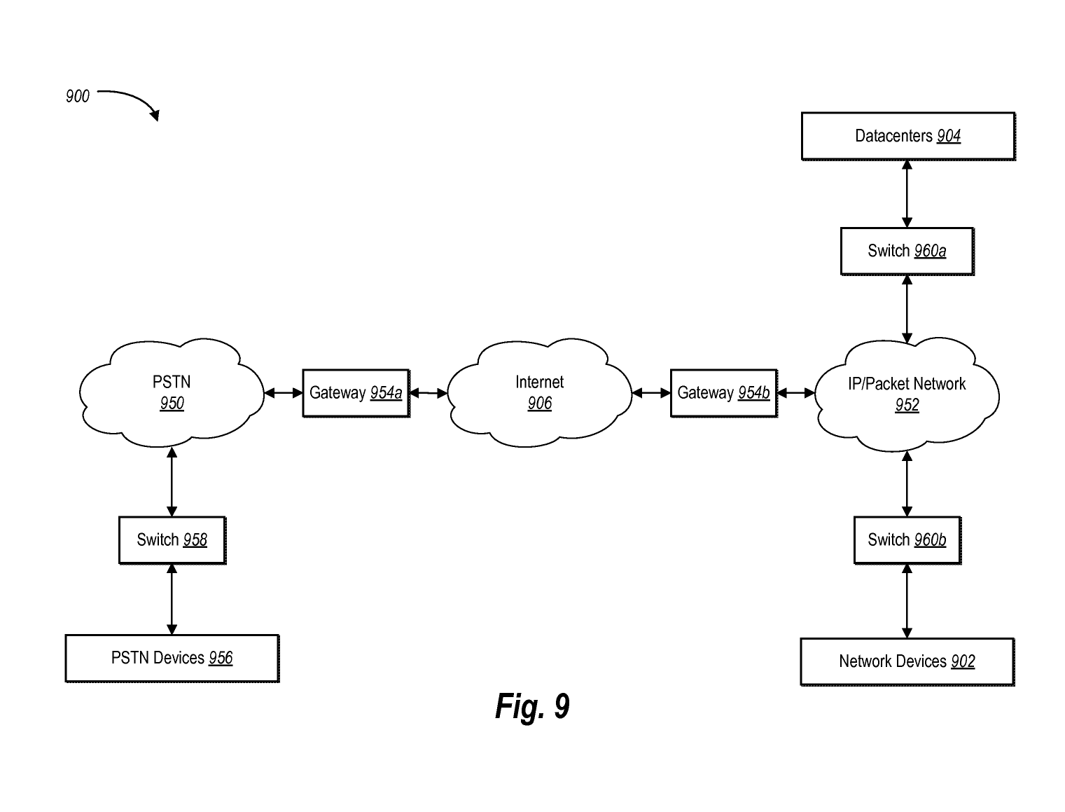

The network device 102 and the datacenters 104 are connected via a network 106. In some configurations, the network 106 may be the Internet, an intranet, a private network, or another type of computer network. The network 106 may be a combination of Internet and intranet networks. Additional details regarding the network will be discussed below with respect to FIG. 9.

The network device 102 can map to the datacenter 104 associated with the optimal available connection (e.g., the optimal available datacenter connection). While connected to one datacenter 104, the network device 102 may determine to remap to another datacenter 104 based on changing network characteristics. For example, the network device 102 may remap its connection from the first datacenter 104a to the nth datacenter 104n based on the available connection with the nth datacenter 104n being superior to the current connection to the network device 102.

In some embodiments, the system 100 can optionally include customer premises equipment 108. The customer premises equipment 108 can determine an optimal available connection for the network device 102. For example, the customer premises equipment 108 can analyze network characteristics between the network device 102 and each datacenter 104 to determine the optimal connection available to the network device 102. In one or more example embodiments, the customer premises equipment 108 can determine connection metrics associated with each datacenter 104 for multiple network devices.

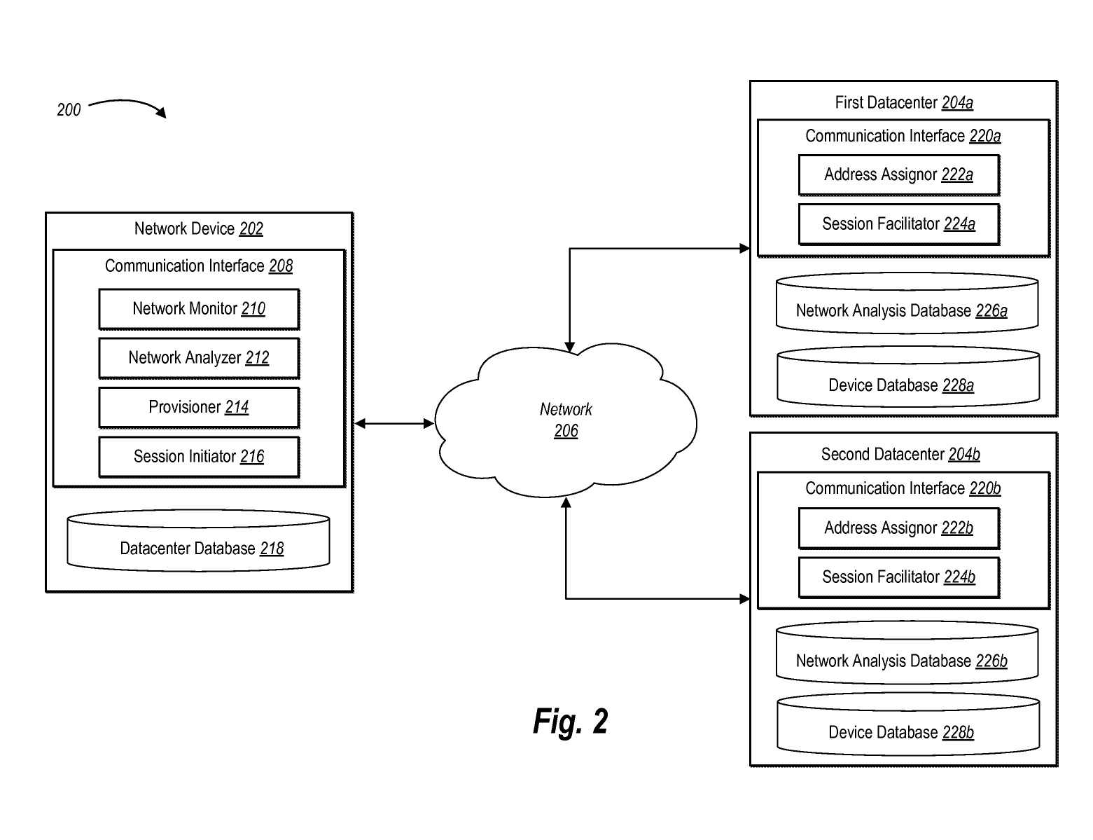

FIG. 2 illustrates an exemplary network-based VoIP communication system 200 (hereafter “VoIP system 200”) according to principles described herein. The VoIP system 200 may be one exemplary configuration of the system 100 described in connection with FIG. 1. For instance, the network device 202 may be one exemplary embodiment of the network device 102. Likewise, the first datacenter 204a and the second datacenter 204b may be exemplary embodiments of the datacenters 104a-n described in connection with FIG. 1.

As illustrated, the VoIP system 200 includes a network device 202, a first datacenter 204a, and a second datacenter 204b. VoIP system 200 is described as having a first datacenter 204a and a second datacenter 204b for ease of explanation. However, the principles described with respect to FIG. 2 can be implemented within a VoIP system 200 having any number of network devices 202 and datacenters 204a, 204b. The network device 202 may connect to the datacenters 204 via the Internet 206. In some configurations, the network device 202 may be directly connected to one or more datacenters 204, or connected via a private network 206. In addition, the network device 202 may securely connect to a datacenter 204 via a secure connection, for example, using secure sockets layer (“SSL”) protocol, or another cryptographic protocol.

In some configurations, the network device 202 may be a VoIP device. The network device 202 may allow a user to communicate with other users. For instance, the network device 202 may facilitate voice and data communication sessions between users. The network device 202 may also allow a user to modify preferences and access voice-messages, each of which may be stored at one or more the datacenters 204. In addition, as described above, users may communicate with their peers using other forms of communication provided by network device 202, such as a videoconference.

The network device 202 includes a communication interface 208. The network device 202 may also include input and output audio/video functionality as described below in connection with FIG. 9. For example, as described in greater detail below, the network device 202 may be a dedicated device, or a soft device, such as a dedicated VoIP device.

The network device 202 employs a communication interface 208 to transmit and receive data. For example, the communication interface 208 may transmit or receive queries, requests, acknowledgements, signals, indications, etc., between the network device 202 and one or more datacenters 204. For example, the communication interface 208 may monitor, analyze, negotiate, and navigate network characteristics for a current connection and available connections.

As illustrated, the communication interface 208 may include a network monitor 210, a network analyzer 212, a provisioner 214, and a session initiator 216. In general, the network monitor 210 monitors connections or available connections corresponding to each datacenter 204. The network analyzer 212 analyzes the monitored network data and determines the optimal available datacenter connection. The provisioner 214 maps and registers the network device 202 to the selected datacenter 204. The session initiator 216 facilitates communications between users via the network device 202. Additional detail regarding each component of the communication interface 208 is discussed in greater detail below.

One of skill in the art should note that each of the above components may be independent from the communication interface 208. For example, the session initiator 216 may be a separate module on the network device 202. In addition, one or more of the above listed components included in the communication interface 208 may be located outside of the network device 202. For example, in some configurations, the network analyzer 212 may be located on a remote computing device, such as customer premises equipment 108. For instance, a business may have a dozen network devices in one location. Rather than each network device determining the optimal datacenter connection, the business may use customer premises equipment 108 that includes the above listed components to determine the optimal available datacenter connection.

In one or more embodiments, one or more of the above listed components listed in the communication interface 208 can be located at a datacenter 204. For example, the first datacenter 204a can include a network monitor 210 and network analyzer 212, and can determine a connection metric between the first datacenter 204a and the network device 202. In addition, in some embodiments, the first datacenter 204a can determined a connection metric between the network device 202 and the second datacenter 204b.

As briefly described above, the network monitor 210 monitors network characteristics corresponding to available connections associated with each datacenter 204. In particular, the network monitor 210 continuously monitors one or more connection factors of available connections between the network device 202 and multiple datacenters 204. For example, the network monitor 210 can survey connection factors of available connections when the network device 202 is first powered on and/or initialized. In addition, when the network device 202 connects to a datacenter 204, the network monitor 210 constantly, or intermittently, monitors the connection between the network device 202 and the datacenter 204. The network monitor 210 also can continue to survey connection factors of other available datacenters connections to which the network device 202 is not currently connected.

In particular, the network monitor 210 continuously monitors connection factors between the network device 202 and multiple datacenters 204 to determine the optimal available datacenter connection. For example, connection factors include, but are not limited to, the shortest response time, number of hops, quality of network connection, reliability of the communication path, amount of network traffic, geographic distance, etc. The network monitor 210 may monitor and measure one or more connection factors and may report data to the network analyzer 212. Each connection factor will be discussed in greater detail below.

One connection factor the network monitor 210 may measure is the shortest response time, such as round-trip time. For example, the network device 202 may probe or ping each datacenter 204 and measure the duration of time it takes to receive an acknowledgement. In some cases, multiple measurements may be taken for each datacenter 204 connection. In these cases, the network monitor 210 may measure a lowest response time, an average response time, a moving average, etc.

The network monitor 210 may measure the shortest response time or round-trip time for multiple datacenters 204. In one configuration, the network monitor 210 measures response time for all online datacenter 204 connections. In another configuration, the network monitor 210 measures response time for only a subset of datacenters 204. For example, the subset may be defined according to geographic proximity, network proximity, past connection history, such as past connectivity metric values, or as directed. In addition, the number of datacenters 204 currently being monitored, as well as which datacenters 204 to monitor, may dynamically change.

In some configurations, the network monitor 210 can employ bi-directional probes to measure response time. For example, in addition to the network monitor 210 measuring the round-trip time of a probe, the network monitor 210 may request that a datacenter 204 performs a similar test in measuring round-trip time between the datacenter 204 and the network device 202. By requesting the datacenter 204 to perform a separate measurement, the network monitor 210 may better capture all-around network characteristics between the network device 202 and the datacenter 204.

The network monitor 210 may measure the number of hops a packet travels between the network device 202 and a datacenter 204. As used herein, a hop is one segment of the path between source and destination, for example, between each router and gateway. The network monitor 210 may measure hops using commonly known commands, such as ping or traceroute/tracepath. In some configurations, the network monitor 210 may measure the total number of hops in the round-trip path from the network device 202 to the datacenter 204 and back.

Similar to the shortest response time, the network monitor 210 may measure the average number of hops between the network device 202 and a specific datacenter 204, such as the first datacenter 204a. For instance, there may be at least a dozen paths that a packet can travel between the network device 202 and the first datacenter 204a. Further, a packet may not employ the same path each time it is sent from the network device 202 to the first datacenter 204a. Thus, if the network monitor 210 measures the number of hops between the network device 202 and the first datacenter 204a multiple times, the network monitor 210 can more accurately determine the number of hops a future packet will require when traveling between the network device 202 to the first datacenter 204a.

In general, a lower the number of hops between the network device 202 and a datacenter 204 indicates a better network connection. This is because a packet traveling between the network device 202 and the datacenter 204, which has a lower number of hops, has been handed off fewer times by routers and gateways. Generally, each handoff increases transmission time, packet processing time, possibilities of error, and the network distance a packet must travel. However, a lower number of hops does not necessarily equate to a better connection. For example, a datacenter 204 that is, on average, ten hops away may require the packet to travel through a slow segment of network, such as an outdated router, while a datacenter 204 that is, on average, fifteen hops away from the network device 202 travels through optimal network segments and has a shorter round-trip time.

Another connection factor that the network monitor 210 may monitor is the network connection quality. For example, the network monitor 210 may identify which entities control the networks, Internet backbones and/or infrastructure a connection must pass through when traveling between the network device 202 and a specific datacenter 204. The network monitor 210 may lookup which entities are associated with high quality networks. For example, the network monitor 210 may recall which entities have previously provided high levels of quality, and which entities have proved problematic in the past. As another measure of quality, the network monitor 210 may monitor the signal strength of a connection verses the amount of interference and noise. Further, the network monitor 210 may base the quality of the network connection on a rating, such as the mean opinion score, which employs a five-point scale: excellent-5; good-4; fair-3; poor-2; and bad-1.

The network monitor 210 may also monitor the reliability of the communication path. For example, the network monitor 210 may observe how often a link is online verses how often the link is down. The network monitor 210 may also observe the duration that a particular link remains online. In general, a link that is only online for short durations, or that periodically goes down may suffer in reliability.

As briefly described above, the network monitor 210 may monitor the amount of network traffic and congestion for each connection between the network device 202 and each datacenter 204. One sign of network congestion is the presence of repeat packet transmission requests. The network monitor 210 may record which datacenter connections require repeat transmissions verses which datacenter connections successfully receive data without requiring additional repetitive transmissions.

In real-time communications, such as in VoIP communications, information is time-sensitive. When data is retransmitted, the amount of time between the data being originally sent and when that data is received increases. Accordingly, information is lost rather than retransmitted because waiting for delayed information, or receiving information out of order may not be an option in a real-time system. For example, if voice data is initially lost over a network connection, that voice data is dropped rather then retransmitted because retransmitting the voice data may cause it to arrive out of order with other voice data, or cause the recipient user to wait an unnatural period of time.

As one example of monitoring network traffic and congestion, the network monitor 210 may monitor the number or percentage of dropped packets in each connection. For example, the connection between the network device 202 and the first datacenter 204a may have 40% dropped packets while the connection with the second datacenter 204b has 1% dropped packets. As described above, dropped packets often require that repeat transmissions be sent, or more importantly, that data may not be received at all in a VoIP system. Thus, dropped packets may indicate only partial amounts of information being sent between users. The number of dropped packets may be a connection factor used in analyzing a connectivity metric for each datacenter 204.

The network monitor 210 may also consider the geographic distance that each datacenter 204 is from the network device 202. Datacenters 204 that are physically closer to the network device 202 may result in a better network connection. For example, the available datacenter connection associated with a datacenter 204 in New York City may provide a superior network characteristics for a network device 202 located in Toronto, than the available datacenter connection associated with a datacenter 204 in Mexico City. However, closer proximity of a datacenter 204 to the network device 202 does not necessarily correlate to a better network characteristics.

One of skill in the art will appreciate that network conditions are a result of multiple variables. Accordingly, the network monitor 210 may monitor one or more of the connection factors disclosed herein. For example, the network monitor 210 may monitor, between the network device 202 and each datacenter 204, the responds time, number of hops, number of dropped packets, and reliability of a connection, among other network characteristics.

In some configurations, the network monitor 210 may progressively monitor various connection factors. For example, the network monitor 210 may measure the shortest response time and the lowest number of hops for each datacenter 204. Based on these results, the network monitor 210 may select a subset of datacenters 204 having above average results, for example. The network monitor 210 may then monitor the subset of datacenters 204 based on the amount of network traffic, number of dropped packets, geographic distance, etc.

The network monitor 210 may send monitored data to the network analyzer 212. For instance, and as briefly described above, the monitored data can represent one or more network characteristics that can be analyzed to determine an optimal connection. In particular, the network analyzer 212 can analyze the network characteristics and determine the quality of the current or potential connections. For example, the network analyzer 212 calculates a connectivity metric for each datacenter connection. Based on the connectivity metric, the network analyzer 212 can determine the optimal available datacenter connection.

The network analyzer 212 may determine a connectivity metric for current connections as well as available connections. For example, when the network device 202 is first initiated, the network analyzer 212 may determine to which datacenter 204 to connect. As another example, the network analyzer 212 may determine both current and available connectivity metrics for each datacenter 204.

Once connected to datacenter 204, the network analyzer 212 may continue to perform network characteristic calculations. For example, after the network device 202 connects to the first datacenter 204a, the network analyzer 212 may continue to calculate a connectivity metric for that connection. The network analyzer 212 may also calculate a connectivity metric for the available connection between the network device 202 and the second datacenter 204b. In this manner, the network device 202 may dynamically determine the datacenter 204 that provides the best connection.

The network analyzer 212 can determine the connectivity metric according to a number of methods. In one or more embodiments, the connectivity metric is one network characteristic identified from one of the monitored connection factors described above. For example, the connectivity metric may be the number of hops, the round-trip time, or the geographical distance. As such, the network analyzer 212 can directly compare a single network characteristic type between multiple datacenters to determine the optimal datacenter connection.

As an example of the connectivity metric being a single connection factor, in one or more embodiments disclosed herein, the connectivity metric may be the round-trip time between the network device 202 and each datacenter 204. Accordingly, in determining the best network connection based on the connectivity metric, the network analyzer 212 may select the datacenter 204 having the shortest round-trip time. For instance, the round-trip time between the network device 202 and the first datacenter 204a is 6 milliseconds (“ms”) while the round-trip time between the network device 202 and the second datacenter 204b is 15 ms. As such, the connectivity metric for the first datacenter 204a is 6 ms and the connectivity metric for the second datacenter 204b is 15 ms. Based on the connectivity metrics, the network analyzer 212 determines that the connection with the first datacenter 204a is superior.

In some embodiments, the network analyzer 212 may generate connectivity metrics using two or more network characteristics corresponding to multiple connection factors. For example, the network analyzer 212 may employ an algorithm that generates connectivity metrics using two or more network characteristics monitored by the network monitor 210. Additional detail regarding one or more algorithms that may be employed to generate a connectivity metric will now be discussed.

In one configuration, the network analyzer 212 may employ an algorithm that generates a connectivity metric based on the number of hops and round-trip time. For instance, the algorithm may divide the number of hops by the round-trip time to determine a connectivity metric. As an example, the network monitor 210 may report that the round-trip time between the network device 202 and the first datacenter 204a is 6 ms, and the first datacenter 204a is 12 hops away from the network device 202. The second datacenter 204b is 15 ms and 20 hops away, respectfully. Thus, the algorithm calculates a connectivity metric for the first datacenter 204a of 2 hop/ms, and a connectivity metric for the second datacenter 204b of 1.33 hops/ms. Accordingly, the network analyzer 212 may determine that the connection with the first datacenter 204a is superior because it has a more favorable connectivity metric.

Alternatively, or in additionally, the network analyzer 212 may again employ an algorithm that generates a connectivity metric based on the number of hops and round-trip time. For instance, the algorithm may multiply the number of hops with the round-trip time to determine a connectivity metric. Using the example number of hops and round-trip time from above, the network analyzer 212 may calculate a connectivity metric of 72 for the first datacenter 204a and a connectivity metric of 300 for the second datacenter 204b. The network analyzer 212 may compare the connectivity metrics and determine that the connection with the first datacenter 204a is superior because it has a lower connectivity metric. Alternatively, the network analyzer 212 may determine that the connection with the second datacenter 204b is superior because it has a higher connectivity metric.

In addition, the algorithm may weight each network characteristic within the algorithm. Greater or lesser weight may be assigned to the various network characteristics. For example, the network analyzer 212 may assign a higher weight to round-trip time and a lesser weight to network connection quality. Weighting may increase or decrease the influence of a network characteristic. For example, a weight above 1 applied to a network characteristic may increase the influence of a network characteristic in the connectivity metric. A weight between 0 and 1 applied to a network characteristic may decrease the influence of the network characteristic in calculating the connectivity metric. Alternatively, if a lower connectivity metric is preferred to a higher connectivity metric, then the opposite effect occurs.

One of skill in the art will appreciate that a variety of weighting methods may be employed in the algorithm to determine a connectivity metric for each datacenter connection. For example, the network analyzer 212 may progressively apply connection factors in determining the optimal datacenter connection. For instance, the network analyzer 212 may select the top five datacenters 204 according to number of hops. Within those top five, the network analyzer 212 may narrow down the results to the top three datacenter 204, based on round-trip time. The network analyzer 212 may then select the optimal datacenter 204 based on the lowest number of dropped packets. One of skill in the art will appreciate that the algorithm used to calculate connectivity metrics may employ various calculations, approaches, and weighting methods.

In some configurations, the network analyzer 212 may store the connectivity metric information. For example, the connectivity metric for each datacenter 204 may be stored in the datacenter database 218. The datacenter database 218 may store a number of connectivity metrics calculated for each datacenter 204 connection. In this manner, the network analyzer 212 may use one or more previous connectivity metrics as one of the connectivity factors in calculating a current connectivity metric for each datacenter 204.

The network device 202 may also send connectivity metric information to one or more datacenters 204. Datacenters 204 can use the connectivity metrics to determine network characteristics across multiple network devices. For example, datacenter 204 may compile connectivity metrics for a set of network devices connected to the datacenter 204. The datacenter 204 may use that information to notify a specific network device 202 of network characteristics. For example, if a network device 202 reports a poor connectivity metric for the second datacenter 204b while adjacent network devices report favorable connectivity metrics for the second datacenter 204b, the datacenter 204 receiving the reports may indicate such to the network device 202. The network device 202 may then use this information as a factor in calculating an updated connectivity metric for the second datacenter 204b.

As another example, both the network device 202 and adjacent network devices may report favorable connectivity metrics for the second datacenter 204b. Subsequently, the adjacent network devices report unfavorable connectivity metrics for the second datacenter 204b, such as a lost connection. The datacenter 204 receiving the reports may indicate that the connection between adjacent network devices and the second datacenter 204b have recently been lost to the network device 202. Again, the network device 202 may then use this information as a connection factor in calculating an updated connectivity metric for the second datacenter 204b. For instance, even though the network device 202 recently calculated a favorable connectivity metric for the second datacenter 204b, the network device apply greater weight to the connection lost information of adjacent network devices.

In some instances, the reporting datacenter 204 may instruct the network device 202 to give greater weight to the reported connection lost information. In this manner, the network device 202 may avoid suffering a connection lost if it is currently connected to the second datacenter 204b. Then, upon receiving information indicating that the connection between adjacent network devices and the second datacenter 204b has been restored, the network device 202 may reduce the weight given to information from the reporting datacenter 204.

Notwithstanding the various methods and processes that the network analyzer 212 can use to determine an optimal datacenter connection, the network analyzer 212 can report the optimal datacenter connection to the provisioner 214. Once the network analyzer 212 reports the optimal datacenter 204 connection to the provisioner 214, the provisioner 214 may start the provisioning and mapping process. For example, the network analyzer 212 may report to the provisioner 214 that the optimal available datacenter connection based on the monitored connection factors and analyzed network characteristics.

Once the network analyzer 212 determines which datacenter 204 has the optimal connectivity metric, the provisioner 214 may map the network device 202 to the selected datacenter 204, and initiate provisioning with the selected datacenter 204. For instance, based on the determination that the first datacenter 204a has the highest, or most favorable, connectivity metric, the provisioner 214 may map to and establish a connection with the first server 204a.

In one or more configurations, mapping the network device 202 includes configuring the network device 202 to connect to the selected datacenter 204. For example, if the network analyzer 212 indicates to the provisioner 214 that the second datacenter 204b connection exhibits the optimal connectivity metric, the provisioner 214 may configure the network device 202 to connect to the second datacenter 204b. In some configurations, mapping may include looking up data associated with the selected datacenter 204, and configuring the network device 202 accordingly. For example, the provisioner 214 may lookup the IP address of the second datacenter 204b and configure the outgoing address of the network device 202 to the IP address of the second datacenter 204b. Alternatively, the provisioner 214 may send out a broadcast, such as an anycast DNS (domain name service) to obtain the IP address of the second datacenter 204b. The IP address of the second datacenter 204b may be an outbound proxy.

The provisioner 214 may provision the network device 202 with the selected datacenter 204. Provisioning may include registering the network device 202 with the selected datacenter 204. In some embodiments, the network device 202 may register with multiple datacenters 204 at the same time. In addition, the provisioning process may involve pairing the network device 202 with the selected datacenter 204. For example, the provisioner 214 may send a request to the selected datacenter 204 requesting that the network device 202 be connected to the datacenter 204.

The datacenter 204 may respond to the request by issuing an identification number or address to the network device 202. In one or more embodiments, the identification number may be unique to the network device 202. For example, the identification number may be tied to the MAC (media access control) address of the network device 202. Alternatively, the identification number may include a phone number assigned to the network device 202. In one or more embodiments, the address may include the unique identification number. This address allows the network device 202 to be contacted by other devices on the system 200. In some instance, the address may be in the form of <unique identification number>@domain.net.

In one or more system 200 configurations, the provisioning process may be in accordance with session protocol, such as SIP. SIP communications exhibit a SIP uniform resource identifier (“URI” or “SIP URI”) that identifies each participant of a SIP session. In one embodiment, the SIP URI comprises a username and a domain in the form of user@domain. Further, the identifier “SIP” may precede the SIP address to indicate that the communication is a SIP communication. For instance, the SIP URI may take the form of SIP:user@domain.net or SIP:user@domain.net:port. In addition, the SIP URI may include a globally-routable domain. For example, one network device 202 is registered with SIP URI userA@domain.com, while a second device is registered with the SIP URI userB@domain.com. In some configurations, a SIP URI may be registered with multiple network devices.

In one or more configurations, before provisioning occurs, the provisioner 214 verifies that a number of provisioning conditions are first satisfied. Provisioning conditions may include the passage of time, satisfying a threshold value, compliance to applicable regulations and laws, etc. For example, when the network analyzer 212 submits an optimal datacenter 204 to connect with, a check may occur to verify if a minimum amount as passed since the last provisioning. In this manner, the provisioner 214 prevents the network device 202 from switching back and forth between datacenters 204 within a short period of time. For example, the provisioner 214 may require that 1 second has elapsed since connecting to the first datacenter 204a before switching to the second datacenter 204b. Accordingly, the systems and methods disclosed herein allow a network device 202 to transition between datacenters 204 in real-time or near real-time such that a user does not detect that a change has occurred.

Similarly, the provisioner 214 may verify that a threshold value has been satisfied before handing off. For example, when the provisioner 214 receives the indication to switch datacenter connection, the provisioner 214 may also receive the connectivity metric for the current datacenter connection and the recommended available datacenter connection. The provisioner 214 may compare the connectivity metrics to determine if the difference between the connectivity metrics satisfies a threshold value. For example, the network device 202 may be connected to the first datacenter 204a and has a connectivity metric of 50%. The provisioner 214 may receive an indication that the second datacenter 204b has a connectivity metric of 55%. However, before a datacenter 204 switch may occur, the recommended datacenter 204 must be 10% higher than the connectivity metric to which the network device 202 is currently connected. Thus, in this example, either the first datacenter's 204a connectivity metric must fall by 5%, the second datacenter's 204b connectivity metric must rise by 5%, or a combination thereof that results in a difference of at least 10%.

Requiring that the threshold value be satisfied prevents the network device 202 from switching between two datacenters 204 that have similar connectivity metrics. For example, over five consecutive periods of time, the network analyzer 212 may report the following connectivity metrics for the first datacenter 204a: 70%, 71% 70% 71%, 70%. The network analyzer 212 also reports the following connectivity metrics for the second datacenter 204b for the time periods: 71%, 70% 71% 70%, 71%. Under these circumstances, the provisioner 214 would alternate connecting with the first datacenter 204a and the second datacenter 204b in each time period. However, in these circumstances, constantly alternating which datacenter 204 the network device 202 should connect with does not provide a significant benefit, and in some instances, hinders the network device 202 because the network device 202 is instructed to connect to one datacenter 204 before it has successfully connected to a previous datacenter 204. Depending on the particular application, however, it may be desirable to not incorporate a threshold, or set a threshold at a value of 0.

The provisioner 214 may also verify compliance with telecommunication laws and regulations, both national and international. For example, a network device 202 in London may determine that the first datacenter 204a, located in New York, has the best connectivity metric. However, an international regulation my restrict communications from entering in the United States. In this case, the provisioner 214 signals to the network analyzer 212 to provide the datacenter 204 having the next best available connection. The provisioner 214 again verifies that connecting to the alternate datacenter 204 connection complies with applicable laws and regulations. For example, the provisioner 214 may perform a table lookup to verify that the network device 202 is authorized to connect to a datacenter 204 located in a specific country, area, or region. In addition, the lookup table may be updated to reflect changes in regulations and laws.

In some configurations, the provisioner 214 may verify that the path a data packet travels does not extend into unauthorized networks. For example, the provisioner 214 may verify that each router and gateway located along the available connection path belongs to an authorized network. For example, the provisioner 214 may receive a path list from the network analyzer 212 for the optimal available datacenter connection path. The path list may include the geographic location of each router and gateway on which a data packet travels. The provisioner 214 may look up the location of each router and gateway in the table, for instance, to verify that data is not traveling beyond approved networks. If the packet data is travelling into one or more unauthorized networks, the provisioner 214 may signal to the network analyzer 212 to provide the provisioner 214 with the next best available datacenter connection, or may request that a different path is employed between the network device 202 and the first selected datacenter 204.

Even while the network device 202 and the selected datacenter 204 are connected, the communication interface 208 may continue to evaluate connectivity characteristics for available connections between the network device 202 and the other datacenters 104. For example, while connected with the first datacenter 104a, the network monitor 210 can continue to monitor network characteristics of the available connection associated with the second datacenter 204b. In addition, the network analyzer 212 can continually update the connectivity metric determined for the second datacenter 204b.

Additionally, as described above, the network monitor 210 and the network analyzer 212 monitors and analyzes the connectivity metric for the current connection with the first datacenter 104a. Accordingly, by continuously monitoring and evaluating network characteristics between the network device 202 and each of the datacenters 204, the network device 202 may dynamically map to the datacenter 204 providing the optimal network connection.

As an example, while connected to the first datacenter 204a, the network device 202, via the network monitor 210 and the network analyzer 212, determines that the second datacenter 204b provides a superior network connection. Based on this determination, the provisioner 212 remaps the network device's 202 connection to the datacenter second 204b and terminates the connection with the first datacenter 104a. The network monitor 210 and the network analyzer 212 may continue to monitor and analyze connectivity characteristics between the network device 202 and each datacenters 204. In this manner, the network device 202 dynamically connects to the best possible datacenter 204 based on the available connection having the best network characteristics. In this manner, the systems and methods disclosed herein provide a user with the best communication experience possible by constantly connecting with the most reliable and responsive datacenter 204.

As another example, the network device 202 may be connected to the second datacenter 204b. Subsequently, the connection with the second datacenter 204b may go down. For instance, the line may be cut or disconnected in some way. Because the network device 202 is constantly monitoring and analyzing alternative network connections, the network device may quickly establish a connection with an alternative datacenter 204, such as the first datacenter 204a. In some instances, the process of detecting a connection loss, and establishing a connection with a new datacenter 204 may occur as quickly and 100 ms, and generally, in less than a second.

As briefly described above, the session initiator 216 facilitates communications between users via the network device 202. For example, the session initiator may initiate audio, video, and other types of communication sessions between users. The session initiator 216 may employ protocol, such as SIP, in facilitating communication sessions between users.

For example, after the provisioner 214 registers and connects the network device 202 to a datacenter 204, the datacenter 204 may provide communications services to the network device 202. For instance, the datacenter 204 may facilitate a communication session between the network device 202 and a second user. In particular, the datacenter 204 may lookup the second user's device address and facilitate a connection between the network device 202 and the second user.

As described above, the network device 202 may send information and reports to one or more datacenters 204. For example, the network device 202 may send a report to the second datacenter 204b. In some configurations, the network device 202 may send connectivity metrics information generated by the network analyzer 212. In addition, the network device 202 may send reports that include network statistics and characteristics between the network device 202 and one or more of the datacenters 204.

Returning to FIG. 2, the VoIP system 200 includes the first datacenter 204a and the second datacenter 204b. As shown, each datacenter 204 has a communication interface 220, which further includes an address assignor 222 and a session facilitator 224, a network analysis database 226, and a device database 228. The communication interface 220 may communicate with the communication interface 208 located on the network device 202. For example, as described above, the provisioner 214 may request to connect with a datacenter 204. In response, the address assignor 220 on the datacenter 204 may assign a device address to the network device 202. The assigned address may also be stored in the device database 228. The device database 228 may also store connection information tied to the network device 202, such as a phone number that reaches the device.

Also, as described above in greater detail, the session initiator 216 may enable user communications on the network device 202 by employing the services offered by the session facilitator 224 located on the datacenter 204. For example, when an address needs to be looked up, such as when a user is attempting to contact another user, the session facilitator 224 may lookup the recipient's device address in the device database 228. The session facilitator 224 may then facilitate a communication session between the two users. For example, the session facilitator 224 may establish and monitor a media bridge between the network devices of the two users.

In some embodiments disclosed herein, each datacenter 204 may monitor, evaluate, and analyze general network characteristics based on the reported data. For example, as described above, one or more network devices may send data to a datacenter 204. For instance, the network device 202 may send connectivity metric information to the first datacenter 204a. Upon receiving the reports, the first datacenter 204a may analyze the data to determine general and underlying network characteristics. The network analysis database 226a may store information regarding connectivity metrics reported by the network device 202 on the first datacenter 204a. In other words, each datacenter 204 may store network characteristic information based on network characteristics received from one or more network devices.

For example, the first datacenter 204a receives reports from network devices. As the first datacenter 204a receives and stores these reports, the first datacenter 204a may monitor the underlying network characteristics and detect network changes. In response, the first datacenter 204a may perform adjustments in the system 200 in response to network changes. As one example adjustment, the first datacenter 204a could prioritize certain network devices over other network devices. In particular, the first datacenter 204a provides increased access to devices associated with emergency services.

Monitoring network characteristics and adjusting network settings may be performed on a system-wide basis, or on a more specific level such as within a group of devices. For example, the datacenter may monitor a group of network devices located in a specific geographical area, such as in a particular city. As another example, the datacenter 204 may group network devices according to IP range, AIS (advanced instruction system) identification number, area code, prefix, etc., or a combination thereof.

The datacenter 204 may report general network characteristic information to the network device 202. The datacenter 204 may also report group-specific network characteristic information to the network device 202. As described above, the network analyzer 212 on the network device 202 may use the network characteristic information reported from the datacenter 204 as a connection factor. For example, the datacenter 204 may inform the network device 202 via the network characteristic information that one or more network devices in a group have recently transitioned from the first datacenter 204a to the second datacenter 204b because the connection with the first datacenter 204a has weakened. In response, the network device 202 may also transition from the first datacenter 204a to the second datacenter 204b. In doing so, the network device 202 may avoid the weakened connection with the first datacenter 204a.

In one embodiment, the network device 202 may be included in a group of network devices. For example, the group of network devices may include all network devices having the same area code, including the network device 202. Accordingly, a datacenter 204 may send reports to the network device 202 based on connectivity reports received from other network devices located in the same area code as the network device 202.

Alternatively, in another embodiment, the network device 202 may not be included in the group of network devices. For example, the group of network devices may include a subset of network devices within an IP range. However, the network device 202 may not belong to the group that sends network characteristic reports to the datacenter 204, even though the network device 202 is included in the IP range. Though the network device 202 is not included in the group, the datacenter 204 may send network characteristic information to the network device 202 based on data received from the datacenter 204. One of skill in the art will appreciate that determining which device belongs in a group may be made based on a number of factors and considerations.

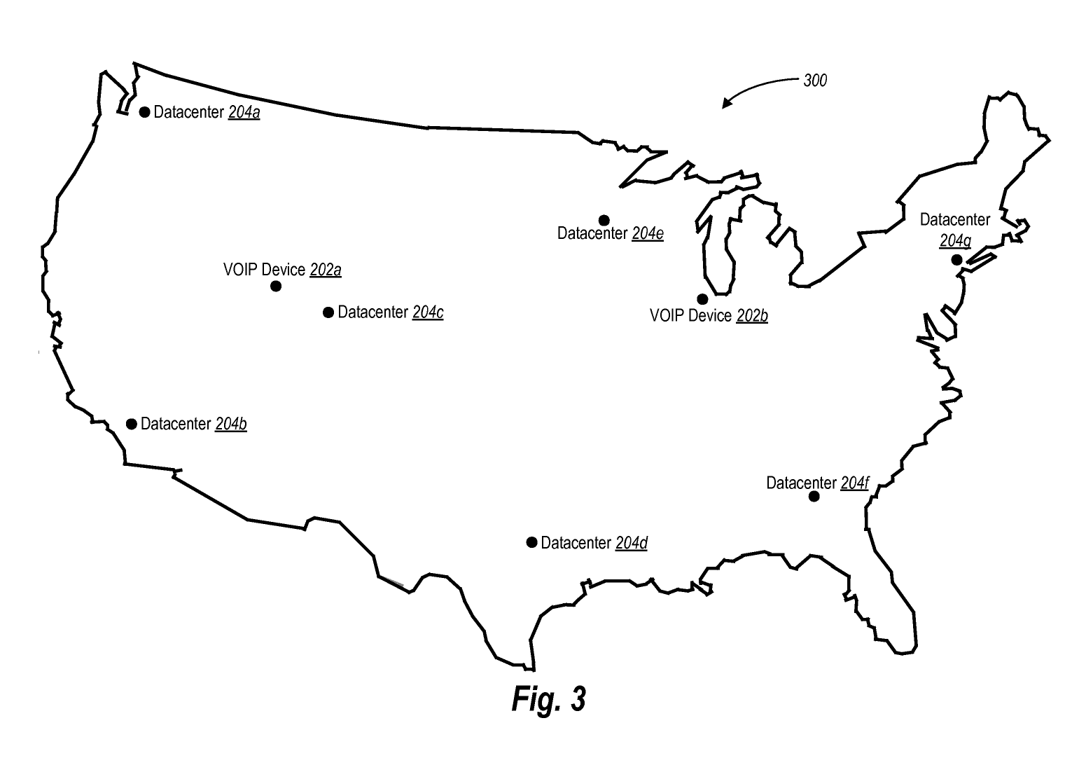

FIG. 3 illustrates an exemplary map 300 where the VoIP communication system 200 of FIG. 2 may be utilized according to principles described herein. In particular, FIG. 3 illustrates a map 300 of the United States where the VoIP system 200 may be employed. One of skill in the art will note, that while FIG. 3 illustrates a map of the United States, the embodiments, configurations, and systems disclosed herein are not limited to any particular geographic regions. For example, the VoIP system 200 may operate across a number of countries, regions, and continental boundaries. For instance, VoIP communication may utilize communication devices located in space.

As illustrated in FIG. 3, the map 300 includes two network devices 202a-b and seven datacenters 204a-g. The datacenters 204 may be geographically distributed throughout the map 300. For example, FIG. 3 illustrates a datacenter 204 in Seattle, Los Angeles, Denver, Dallas, Minneapolis, Atlanta, and New York City. One of skill in the will appreciate that the datacenters 204 are not limited to any particular geographic locations. Similarly, the network devices 302 are also not location specific.

For simplicity, only two network devices 202 are illustrated. In particular, the first network device 202a is located in Salt Lake City, and the second network device 202b is located in Chicago. While not illustrated, the map 300 may include a number of other network devices 202. For example, multiple network devices 202 may be located in the same location as well as located throughout various locations.

To illustrate, a first user in Salt Lake City may desire to communicate with a second user in Chicago. The first user in Salt Lake City may be associated with the first network device 202a, and the second user in Chicago may be associated with the second network device 202b. However, before either user can participate in a communication session, each network device 202 must be mapped to and register with one of the datacenters 204.

Accordingly, the first device 202a may determine to which datacenter 204 to map. For example, a network monitor 210 on the first network device 202a monitors one or more connection factors for available connections to each of the seven datacenters 204a-g to identify one or more network characteristics. Then, a network analyzer 212 on the first device 202a analyzes the one or more network characteristics to determine a connectivity metric for each available connection associated with the seven datacenters 204a-g. For instance, the available connection associated with the Los Angeles datacenter 204b may have the highest rated connectivity metric compared to the available connections associated with the other datacenters 204.

The first network device 202a may then connect with the datacenter 204 having the highest rated, or most favorable connectivity metric, such as the Los Angeles datacenter 204b. In particular, the provisioner 212 on the first network device 202a can map to the Los Angeles datacenter 204b. In addition, the provisioner 212 can request to connect with the Los Angeles datacenter 204b. The Los Angeles datacenter 204b may then provision and register the first network device 202a. For example, the address assigner 220 on the Los Angeles datacenter 204b may assign an address to the first network device 202a.

In a similar manner, the second network device 202b may monitor network characteristics, calculate a connectivity metric for each datacenter 204, and provision with the datacenter 204 having the highest rated connectivity metric. For example, the second network device 202b may determine that the Atlanta datacenter 204f has the most favorable connectivity metric. The second network device's 202b provisioner 214 may map to and register with the Atlanta datacenter 204f based on the connectivity metric results.

In some configurations, network devices 202a-b may employ different methods in monitoring and analyzing network characteristics. For example, the first network device 202a may calculate a connectivity metric for each datacenter 204 based on the geographic proximity to each datacenter 204 and number of hops. The second network device 202b may determine a connectivity metric for each datacenter 204 based on the round-trip time and number of dropped packets. In one or more embodiments, the way the connectivity metric can be based on or correspond to one or more user preferences.

Once the first network device 202a and the second network device 202b are each connected to a datacenter 204, the first user and the second user may communicate in a communication session. For example, the first user may call the second user. In particular, when calling the second user, the first network device's 202a session initiator 216 notifies the Los Angeles datacenter 204b that the first network device 202a would like to connect with the second network device 202b. The Los Angeles datacenter 204b looks up the address for the second network device 202b, for example, in the device database 228. The Los Angeles datacenter 204b also facilitates a connection between the first network device 202a and the second network device 202b. For instance, the session facilitator 224 at the Los Angeles datacenter 204b may set up and monitor a media bridge between the two network devices 202a-b.

In some configurations, the media bridge between the first network device 202a and the second network device 202b is routed through the one or more datacenters 204. For example, the media bridge may be routed through the Los Angeles datacenter 204b and/or the Atlanta datacenter 204f. Additionally or alternatively, the media bridge may be routed though other datacenters 204.

In another configuration, the media bridge is directly connected between the first network device 202a and the second network device 202b. For example, the session facilitator 224 at the Los Angeles datacenter 204b may facilitate a direct communication path between the first network device 202a and the second network device 202b. Nevertheless, even though the first network device 202a is directly connected to the second network device 202b, a datacenter 204 may monitor the status of the communication session. For example, the session facilitator 224 at the Los Angeles datacenter 204b monitors the current communication session by receiving status updates from the first network device 202a as long as the call is active.

In some embodiments, the status updates may include a connectivity metric between the first network device 202a and the second network device 202b. In particular, the monitoring datacenter 204 may continuously determine one or more alternative media bridge communication paths between the first network device 202a and the second network device 202b based on changing network characteristics. Thus, if the original media bridge connection fails, gets cut off, or the connectivity metric falls bellows a preset quality level, the Los Angeles datacenter 204b may provide the alternate media bridge communication path to the first network device 202a. Thus, a communication session between two users can continue seamlessly interrupted, even in the event of a poor media bridge or lost connection.

Furthermore, during a communication session, the network devices 202 may continue to determine the optimal available connection to connect to a datacenter 204. For instance, even though the second user is currently talking with the first user via a direct media bridge connection, the second network device 202b may determine that the connectivity metric with the available connection associated with the Minneapolis datacenter 204e is superior than the current connectivity metric for the connection with the Atlanta datacenter 204f. As such, the second network device 202b establishes a connection with the Minneapolis datacenter 204e and terminates its connection with the Atlanta datacenter 204f. Transitioning between various datacenters 205 may occur seamlessly while the first user and the second user are participating in a real-time communication session. Thus, the transition is such that neither the first user nor the second user detects the changeover.

As described above, switching between multiple datacenters 204 may occur when the network device 202 is not actively in a communication session. In particular, the network device 202 may continuously monitor and analyze available connections to determine if any available connection is superior to the current connection even when the network device 202 is not in a communication session. For example, the network device 202 may continue to monitor and analyze a connectivity metric for the available connection associated with the second datacenter 204b while currently connected to the first datacenter 204a. Upon determining that the available connection for the second datacenter 204b is superior, the network device 202 may switch connections to the second datacenter 204b.

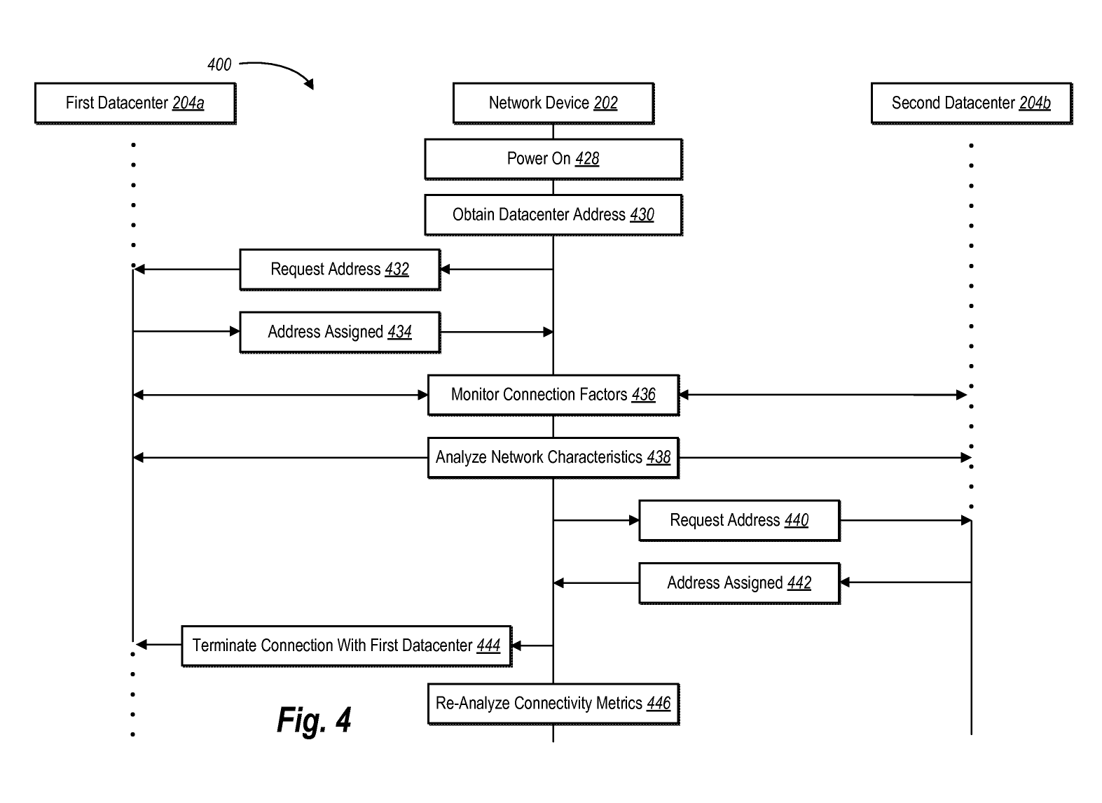

FIG. 4 illustrates a sequence-flow method 400 illustrating interactions between a network device 202, the first datacenter 204a, and the second datacenter 204b in the VoIP communication system 200 of FIG. 2 in accordance with one or more embodiments disclosed herein. In particular, the method 400 of FIG. 4 illustrates an example method of the network device 202 mapping to multiple datacenters 204 based on changing network characteristics.

In addition, as shown in FIG. 4, when the network device 202 is mapped to the first datacenter 204a, a solid line below the first datacenter 204a is shown. When the network device 202 is not mapped to the first datacenter 204a, a dotted line is shown. Similarly, FIG. 4 shows a solid line under the second datacenter 204b when the network device 202 is mapped to the second datacenter 204b and a dotted line when the network device 202 is not.

To illustrate, in step 428 the network device 202 may power on. Powering on may include both connecting the network device 202 to a power source as well as connecting the network device 202 to a network source. For example, the network device 202 may negotiate an IP address from a local router and establish connectivity to the Internet 206.

Step 430 can include the network device 202 obtaining an address for the VoIP system 200. For example, step 430 can include the network device 202 obtaining a hostname associated with first datacenter 204a. For instance, when a network device 202 is first powered on 428, the network device 202 can connect to a third-party, such as a manufacturer of the network device 202, to obtain an address for one or more datacenters 204. Alternatively, the network device 202 can have an addresses or hostname associated with the VoIP system 200 stored on the network device 202. For example, the network device 202 may have the address of one or more datacenters 204 programmed into network device 202 at the time the network device 202 is manufactured.

Step 432 may include the network device 202 requesting an address from the first datacenter 204a. For example, the network device 202 may send an identification number to the VoIP system 200 when requesting an address. The identification number may be unique to the network device 202 requesting an address, such as the phone number assigned to the network device 202. Alternatively, the identification number may be a number randomly assigned by the VoIP system 200.

In some configurations, the network device 202 may be configured to initially map to a specific datacenter 204. For example, the network device 202 may be programmed at the factory to first map to the first datacenter 204a. In this manner, the network device 202 may map to and be recognized with the VoIP system 200.

In one or more embodiments, the network device 202 may obtain a list of multiple datacenters with which to potentially connect. For example, the network device 202 may be configured to initially contact a host at specific address, such as domain.com, to obtain a list of one or more datacenters. For instance, the network device 202 may receive a list of datacenter addresses from the host. The network device 202 may then determine which datacenter 204 has the optimal connection.

In some cases, the network device 202 may be configured to determine which available datacenter connection is optimal. For example, the network device's 202 provisioner 214 may map to and connect with the datacenter 204 that exhibits the best connectivity metric. Additional detail regarding mapping to and connecting with a datacenter 204 is described above in connection with FIG. 2.

Step 434 may include the first datacenter 204a assigning an address to the network device 202. As described above, the address assigner 220 on the first datacenter 204a may assign an address to the network device 202. Further, the address assigner 220 may notify other devices on the VoIP system 200, such as other datacenters 204, of the address assigned to network device 202.

In some instances, the address given to the network device 202 by the address assigner 220 may be datacenter 204 specific. Thus, the address assigned by the first datacenter 204a may be different from an address assigned from the second datacenter 204b. For example, the address may be the identification number of the network device 202, followed by an indication of which datacenter is assigning the address, followed by an indication of the system to which the device is connected. For instance, if the network device 202 had an identification number of WA01BC99, the second datacenter may give the network device 202 the address WA01BC992@datacenter2.VoIPSystem.net. Similarly, the first datacenter 204a may give the network device 202 the address WA01BC992@datacenter1.VoIPSystem.net.

Alternatively, the address may not indicate which datacenter 204 assigned the address to the network device 202. For example, the address may be the same for the network device 202 regardless of which datacenter 204 assigned the address. For instance, as the above example sets forth, the address of the network device 202 may be WA01BC992@VoIPSystem.net. In addition, when a datacenter connects with the network device 202, it may assign an address that is independent from addresses previous assigned to the network device 202 by another datacenter 204.

Step 436 may include the network device 202 monitoring connection factors. As described above in greater detail, the network monitor 210 on the network device 202 may monitor for one or more connection factors to determine one or more network characteristics. In addition, the network monitor 210 may continue to monitor for network characteristics even when currently connected to a datacenter. For example, while the network device 202 is connected to the first datacenter 204a, the network monitor continues to monitor the connection factors for both the first datacenter 204a and the second datacenter 204b. In this manner, the network device 202 may continue to detect when changes in available connections occur.

Step 438 may include the network device 202 analyzing the network characteristics. In particular, the network device 202 may determine connectivity metrics for each datacenter 204 based on the current network characteristics. For example, the network device's 202 network analyzer 212 may calculate a connectivity metric for each datacenter 204. Additional detail regarding calculating the connectivity metric for each datacenter 204 is provided above in connection with FIG. 2.

The network device 202 may determine, based on the connectivity metric, that its current connection remains the most favorable connection. Alternatively, the network device 202 may determine that another available datacenter connection is preferable to the current connection. For example, the network device 202 may determine, based on comparing connectivity metrics, that the second datacenter 204b is the optimal datacenter 204 to which to connect.

Step 440 may include the network device 202 requesting to connect with the second datacenter 204b. In particular, when the network device 202 determines that the second datacenter 204b is the optimal datacenter 204 to connect to, the network device 202 may map to the second datacenter 204b. The network device 202 may also request a registered address from the second datacenter 204b. For example, the provisioner 214 on the network device 202 may request and obtain an address from the second datacenter 204b, as described above.

The second datacenter 204b may assign an address to the network device 202, as shown in step 442. For instance, the address assigner 220 on the second datacenter 204b may assign an address to the network device 202. As described above, the address assigner 220 may notify other devices on the VoIP system 200, such as other datacenters 204, of the address assigned to network device 202. The second datacenter 204a may store the assigned address in its device database 228. Further, the address assigned to the network device 202 may be datacenter 204 specific and/or independent from the previous address assigned to the network device 202. The network device 202 may be connected to the second datacenter 204b once assigned an address.

Step 444 may include terminating the connection with the first datacenter 204a. In one configuration, the network device 202 may terminate the connection with the first datacenter 204a only after a connection with the second datacenter 204b is established. In this manner, there is a connection overlap between the connection with the first datacenter 204a and the second datacenter 204b. Alternatively, the network device 202 may terminate the connection with the first datacenter 204a prior to, or simultaneously with connecting to the second datacenter 204b.

As described above, switching connections between datacenters 204 may occur during a communication session. Whether switching during a communication session or not, the transition is such that the user of the network device 202 does not detect the changeover. Thus, in the event that the network device 202 becomes disconnected from a datacenter 204, the network device 202 may connect with an alternative datacenter 204 before the user detects the disconnection.

Step 446 may include reanalyzing connectivity metrics for each datacenter 204. The network device 202 may continuously monitor network characteristics for changes. As network changes occur, the network device 202 may re-analyze and re-calculate connectivity metrics for each datacenter 204, including the datacenter 204 to which the network device 202 is actively connected. In other words, the network device 202 may continuously repeat the steps 436-444 of method 400. In this manner, the network device 202 dynamically monitors, analyzes, and connects to the best datacenter 204 available based on changing network characteristics.

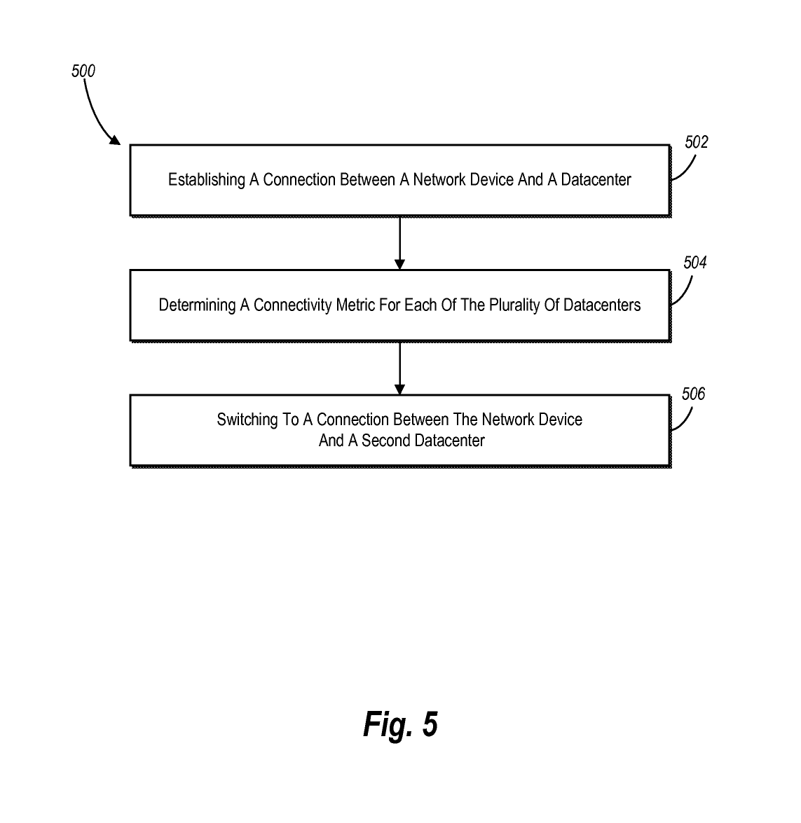

FIGS. 1-4, the corresponding text, and the examples, provide a number of different systems and devices for providing a network based communication system. In addition to the foregoing, embodiments also can be described in terms of flowcharts comprising acts and steps in a method for accomplishing a particular result. For example, FIGS. 5-7 illustrate flowcharts of example methods in accordance with one or more embodiments. The methods described in relation to FIGS. 5-7 may be performed with less or more steps/acts or the steps/acts may be performed in differing orders. Additionally, the steps/acts described herein may be repeated or performed in parallel with one another or in parallel with different instances of the same or similar steps/acts. One or more of the steps shown in FIGS. 5-7 may be performed by any component or combination of components of system 200.

FIG. 5 illustrates a flowchart of one exemplary method 500 of providing a network based communication system. Step 502 may include establishing a connection between a network device 202 and a datacenter 204. In particular, step 502 may include establishing a first connection between the network device 202 and a first datacenter 204a of a plurality of datacenters. To illustrate, the communication interface 208 on the network device 202 may establish a connection with the communication interface 220a on the first datacenter 204a. In particular, the provisioner 214 on the network device 202 may establish a connection with the first datacenter 204a in any suitable manner, such as described herein. In some instances, the network device 202 may establish the connection with the first datacenter 204a using a signaling protocol, such as SIP.

Step 504 may include determining a connectivity metric for each of the plurality of datacenters 204. In particular, step 504 may include determining a plurality of connectivity metrics that corresponds to each of the plurality of datacenters 204. For example, the network analyzer 212 may determine a connectivity metric between the network device 202 and each of the datacenters in any suitable manner, such as described herein. To illustrate, the network analyzer 212 may calculate a connectivity metric for each datacenter 204 based on data received from the network analyzer 210. For instance, the network monitor 210 may monitor network characteristics that corresponds to each datacenter 204 based on the quality of network connections, response times, communication path reliability, network traffic metrics, geographic proximity, number of hops, and/or previous paths employed.

Step 506 may include switching to a connection between the network device 202 and a second datacenter 204b. In particular, step 506 may include switching from the first connection to a second connection between the network device 202 and a second datacenter 204b of the plurality of datacenters 204 when a connectivity metric that corresponds to the second datacenter 204b is superior to a connectivity metric that corresponds to the first datacenter 204a. For example, if the connectivity metric for the second datacenter 204b is superior to, or exceeds the connectivity metric for the first datacenter 204a, the network device 202 may switch connections from the first datacenter 204a to the second datacenter 204b in any suitable manner, such as described herein. In some instances, the network device 202 may switch when the connectivity metric for the second datacenter 204b exceeds the connectivity metric for the first datacenter 204a by a threshold value. Further, in switching connections to the second datacenter 204b, the network device 202 may terminate its connection with the first datacenter 204a.

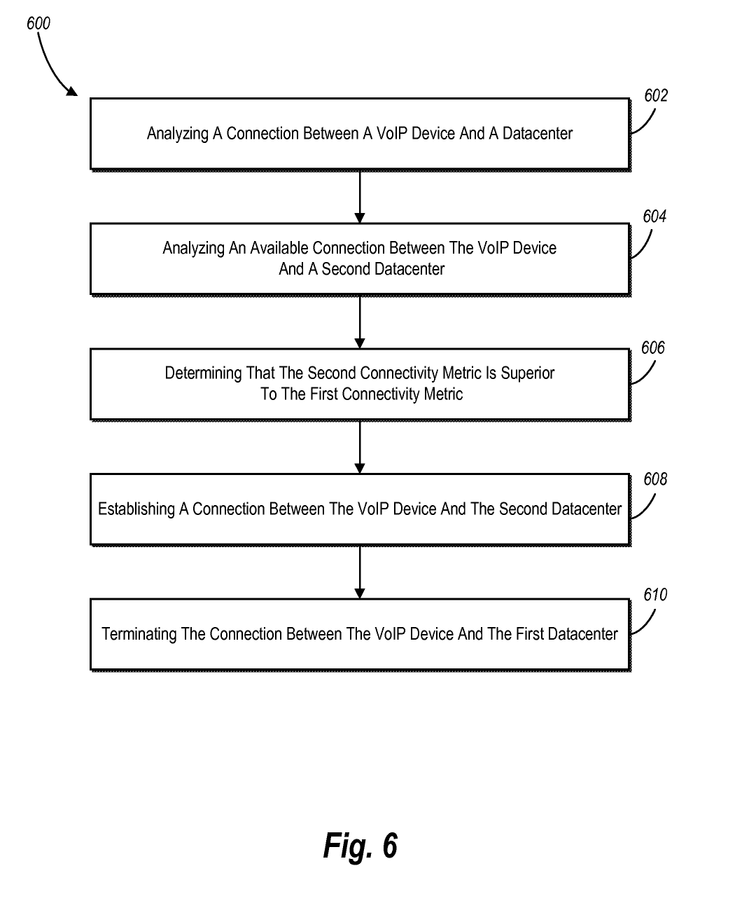

FIG. 6 illustrates another method 600 of dynamically associating a network device 202 with a datacenter 204 according to the principles described herein. Step 602 may include analyzing a connection between a VoIP device 202 and a datacenter 204a. In particular, step 602 may include analyzing a first connection between a voice-over internet protocol device 202 and a first datacenter 204a to obtain a first connectivity metric. For example, the network analyzer 212 on the network device 202 may calculate a connectivity metric between the network device 202 and the first datacenter 204a in any suitable manner, such as described herein. As described above, in one or more configurations, the network device 202 may be configured as a VoIP device.

Step 604 may include analyzing an available connection between the VoIP device 202 and a second datacenter 204b. In particular, step 604 may include analyzing an available connection between the voice-over internet protocol device 202 and a second datacenter 204b to obtain a second connectivity metric. For instance, the network analyzer 212 on the network device 202 may calculate a connectivity metric for the available connection associated with the second datacenter 204b in any suitable manner, such as described herein.

Step 606 may include determining that the second connectivity metric is superior to the first connectivity metric. In particular, step 606 may include determining that the second connectivity metric is superior to the first connectivity metric. For example, the network analyzer 212 may compare the connectivity metric from the first datacenter 204a with the connectivity metric from the second datacenter 204b in any suitable manner, such as described herein. To illustrate, the network analyzer 212 may determine that the second connectivity metric is superior to the first connectivity metric based on the quality of network connections, response times, communication path reliability, network traffic metrics, geographic proximity, number of hops, and/or previous paths employed.

Step 608 may include establishing a connection between the VoIP device 202 and the second datacenter 204b. In particular, based on the second connectivity metric being superior to the first connectivity metric, step 608 may include establishing a second connection between the voice-over internet protocol device 202 and the second datacenter 204b. For example, the network analyzer 212 may indicate to the provisioner 214 that the connectivity metric for the available connection between the second datacenter 204b provides better network characteristics. The provisioner 214 may then map to and connect with the second datacenter 204b in any suitable manner, such as described herein.

Step 610 may include terminating the connection between the VoIP device 202 and the first datacenter 204a. In particular, step 610 may include terminating the first connection between the voice-over internet protocol device 202 and the first datacenter 204a upon establishing the second connection between the voice-over internet protocol device 202 and the second datacenter 204b. To illustrate, the provisioner 214 may terminate the first connection with the first datacenter 204a in any suitable manner, such as described herein. The steps of establishing the connection with the second datacenter 204b and terminating the connection with the first datacenter 204a may occur is such a manner that a user does not detect the changeover.

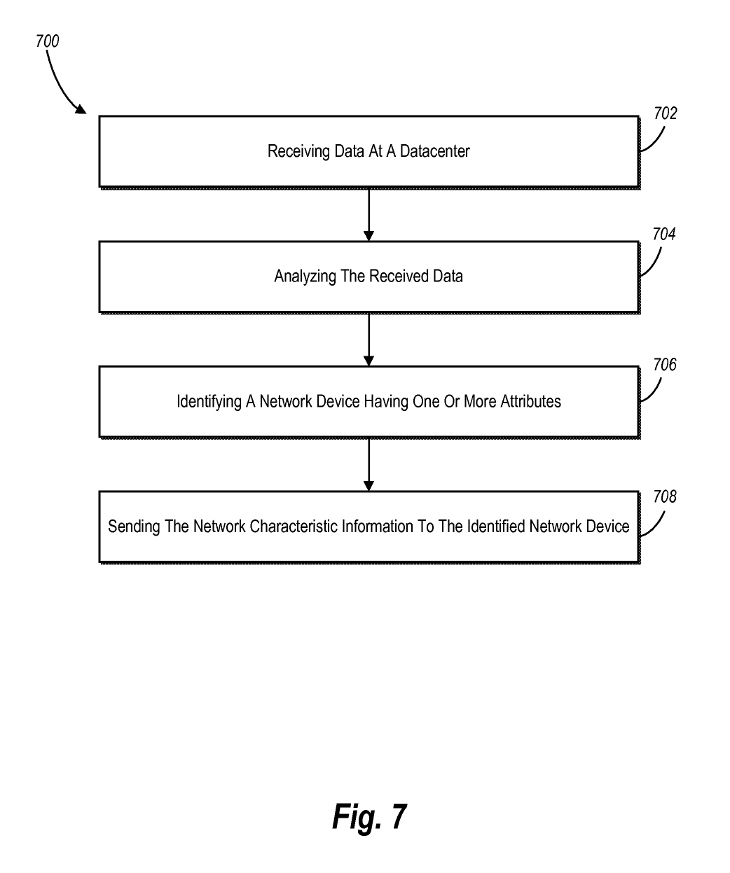

FIG. 7 illustrates an exemplary method 700 of monitoring and maintaining a dynamic VoIP communication system 200 according to the principles described herein. Step 702 may include receiving data at a datacenter 204a. In particular, step 702 may include receiving data from one or more network devices 202 connected to a first datacenter 204a. For example, the first datacenter 204a may receive data from a network device 202 including current network characteristics between the network device 202 and one of more datacenters 204. To illustrate, the network device 202 may send connectivity metrics calculated for each datacenter to the first datacenter 204a.

Step 704 may include analyzing the received data. In particular, step 704 may include analyzing the data received from the one or more network devices 202 to determine network characteristic information. For example, the first datacenter 204a may analyze the data to determine network characteristic information in any suitable manner, such as described herein. To illustrate, the first datacenter 204a may determine that the connectivity metric for a specific datacenter, such as the second datacenter 204b, has weakened below a threshold value based on network characteristic information received from one or more network devices 202.

Step 706 may include identifying a network device 202 having one or more attributes. In particular, step 702 may include identifying a network device 202 having one or more attributes related to the one or more network devices. For example, the first datacenter 204a may group multiple network devices together, as describe above. For instance, the group may be based on network proximity, geographic proximity, address proximity, routing proximity, etc. The identified network device 202 may be included as part of the group or, in some instances, may not belong to the group, as described in greater detail above.

Step 708 may include sending the network characteristic information to the identified network device 202. In particular, step 702 may include sending the network characteristic information to the identified network device 202 based on the analyzed data. For example, the first datacenter 204a may instruct the network device 202 to establish a connection with the second datacenter 204b. The instructions from the first datacenter 204a may be used by the network device 202 to determine a connectivity metric for one or more datacenters 204, such as described herein.

FIG. 8 illustrates, in block diagram form, an exemplary computing device 800 that may be configured to perform one or more of the processes described above. One will appreciate that system 100, and/or VoIP system 200 each comprises one or more computing devices in accordance with implementations of computing device 800. As shown by FIG. 8, the computing device can comprise a processor 802, a memory 804, a storage device 806, an I/O interface 808, and a communication interface 810, which may be communicatively coupled by way of communication infrastructure 812. While an exemplary computing device 800 is shown in FIG. 8, the components illustrated in FIG. 8 are not intended to be limiting. Additional or alternative components may be used in other embodiments. Furthermore, in certain embodiments, a computing device 800 can include fewer components than those shown in FIG. 8. Components of computing device 800 shown in FIG. 8 will now be described in additional detail.

In particular embodiments, processor 802 includes hardware for executing instructions, such as those making up a computer program. As an example and not by way of limitation, to execute instructions, processor 802 may retrieve (or fetch) the instructions from an internal register, an internal cache, memory 804, or storage device 806 and decode and execute them. In particular embodiments, processor 802 may include one or more internal caches for data, instructions, or addresses. As an example and not by way of limitation, processor 802 may include one or more instruction caches, one or more data caches, and one or more translation lookaside buffers (“TLBs”). Instructions in the instruction caches may be copies of instructions in memory 804 or storage 806.

Memory 804 may be used for storing data, metadata, and programs for execution by the processor(s). Memory 804 may include one or more of volatile and non-volatile memories, such as random access memory (“RAM”), read only memory (“ROM”), a solid-state disk (“SSD”), flash, phase change memory (“PCM”), or other types of data storage. Memory 804 may be internal or distributed memory.

Storage device 806 includes storage for storing data or instructions. As an example and not by way of limitation, storage device 806 can comprise a non-transitory storage medium described above. Storage device 806 may include a hard disk drive (“HDD”), a floppy disk drive, flash memory, an optical disc, a magneto-optical disc, magnetic tape, or a universal serial bus (“USB”) drive or a combination of two or more of these. Storage device 806 may include removable or non-removable (or fixed) media, where appropriate. Storage device 806 may be internal or external to the computing device 800. In particular embodiments, storage device 806 is non-volatile, solid-state memory. In other embodiments, Storage device 806 includes read-only memory (“ROM”). Where appropriate, this ROM may be mask programmed ROM, programmable ROM (“PROM”), erasable PROM (“EPROM”), electrically erasable PROM (“EEPROM”), electrically alterable ROM (“EAROM”), or flash memory or a combination of two or more of these.

I/O interface 808 allows a user to provide input to, receive output from, and otherwise transfer data to and receive data from computing device 800. I/O interface 808 may include a mouse, a keypad or a keyboard, a touch screen, a camera, an optical scanner, network interface, modem, other known I/O devices or a combination of such I/O interfaces. I/O interface 808 may include one or more devices for presenting output to a user, including, but not limited to, a graphics engine, a display (e.g., a display screen), one or more output drivers (e.g., display drivers), one or more audio speakers, and one or more audio drivers. In certain embodiments, I/O interface 808 is configured to provide graphical data to a display for presentation to a user. The graphical data may be representative of one or more graphical user interfaces and/or any other graphical content as may serve a particular implementation.

Communication interface 810 can include hardware, software, or both. In any event, communication interface 810 can provide one or more interfaces for communication (such as, for example, packet-based communication) between computing device 800 and one or more other computing devices or networks. As an example and not by way of limitation, communication interface 810 may include a network interface controller (“NIC”) or network adapter for communicating with an Ethernet or other wire-based network or a wireless NIC (“WNIC”) or wireless adapter for communicating with a wireless network, such as WI-FI.

Additionally or alternatively, communication interface 810 may facilitate communications with an ad hoc network, a personal area network (“PAN”), a local area network (“LAN”), a wide area network (“WAN”), a metropolitan area network (“MAN”), or one or more portions of the Internet or a combination of two or more of these. One or more portions of one or more of these networks may be wired or wireless. As an example, communication interface 810 may facilitate communications with a wireless PAN (“WPAN”) (such as, for example, a BLUETOOTH WPAN), a WI-FI network, a WI-MAX network, a cellular telephone network (such as, for example, a global system for mobile communications (“GSM”) network), a satellite network, a navigation network, a broadband network, a narrowband network, the Internet, a local area network, or any other networks capable of carrying data and/or communications signals between a network device 102 and one or more datacenters 104.

To illustrate, the communication interface may communicate using any communication platforms and technologies suitable for transporting data and/or communication signals, including known communication technologies, devices, media, and protocols supportive of remote data communications, examples of which include, but are not limited to, data transmission media, communications devices, transmission control protocol (“TCP”), internet protocol (“IP”), file transfer protocol (“FTP”), telnet, hypertext transfer protocol (“HTTP”), hypertext transfer protocol secure (“HTTPS”), session initiation protocol (“SIP”), simple object access protocol (“SOAP”), extensible mark-up language (“XML”) and variations thereof, simple mail transfer protocol (“SMTP”), real-time transport protocol (“RTP”), user datagram protocol (“UDP”), global system for mobile communications (“GSM”) technologies, enhanced data rates for GSM evolution (“EDGE”) technologies, code division multiple access (“CDMA”) technologies, time division multiple access (“TDMA”) technologies, short message service (“SMS”), multimedia message service (“MMS”), radio frequency (“RF”) signaling technologies, wireless communication technologies, in-band and out-of-band signaling technologies, and other suitable communications networks and technologies.

Communication infrastructure 812 may include hardware, software, or both that couples components of computing device 800 to each other. As an example and not by way of limitation, communication infrastructure 812 may include an accelerated graphics port (“AGP”) or other graphics bus, an enhanced industry standard architecture (“EISA”) bus, a front-side bus (“FSB”), a hypertransport (“HT”) interconnect, an industry standard architecture (“ISA”) bus, an infiniband interconnect, a low-pin-count (“LPC”) bus, a memory bus, a micro channel architecture (“MCA”) bus, a peripheral component interconnect (“PCI”) bus, a PCI-Express (“PCIe”) bus, a serial advanced technology attachment (“SATA”) bus, a video electronics standards association local (“VLB”) bus, or another suitable bus or a combination thereof.

FIG. 9 illustrates an example network environment of a telecommunications system 900 according to the principles described herein. In particular, the telecommunications system 900 may facilitate both network-based communication systems as well as circuited-switched traditional communication systems. For example, the telecommunications system 900 may allow a user calling from a traditional landline to converse with a user using a VoIP device. In addition, while FIG. 9 illustrates exemplary components and devices according to one embodiment, other embodiments may omit, add to, reorder, and/or modify any of the components and devices shown in FIG. 9.

The telecommunication system 900 may include a PTSN 950 and an IP/packet network 950. The PTSN 950 and the IP/packet network 952 may be connected via a network, such as the Internet 906 or over a private network. In some configurations, the PTSN 950 and/or the IP/packet network 952 may be connected to the Internet 906 via gateways 954a-b. For example, gateway 954b may be a signaling gateway and/or a media gateway. For instance, the signaling gateway processes and translates bidirectional SIP signals, and the media gateway handles real-time transport protocol communications. In addition, network trunks may interconnect the PTSN 950, the Internet 906, and the IP/packet network 950.

The PSTN 950 may connect to one or more PSTN devices 956. For example, a switch 958 may connect the one or more PSTN devices 956 to the PSTN 950. PSTN devices 956 may include a variety of devices ranging from traditional landline devices to mobile/cellular devices.

The PSTN 950 may include, but is not limited to telephone lines, fiber optic cables, microwave transmission links, cellular networks, communications satellites, and undersea telephone cables. Switching centers may interconnect each of this components and networks. Further, the PSTN 950 may be analog or digital. In addition, the PSTN 950 may use protocols such as common channel signaling system 7 (“CCS7”). CCS7 is a set of protocols used in the PSTN 950 to setup and tear down communications between subscribers (i.e., users).

As illustrated in FIG. 9, the telecommunications system 900 may include an IP/packet network 952. The IP/packet network 952 may be part of a network-based system, such as a VoIP communication system. VoIP systems are generally known for transmitting voice packets between users. However, VoIP systems also handle other forms of communication, such as video, audio, photographs, multimedia, data, etc. For example, VoIP systems provide communication services for telephone calls, faxes, text messages, and voice-messages.

The IP/packet network 952 provides communications services between users over the Internet 906 rather than using a traditional PSTN 950. However, VoIP systems also allow users to communicate with users using PSTN 950. Thus, a subscriber using a network device 902 may communicate with a subscriber using a PSTN device 956. Furthermore, VoIP systems allow users to communicate with each other without accessing the PSTN 950.

Embodiments disclosed herein may comprise or utilize a special purpose or general-purpose computer including computer hardware, such as, for example, one or more processors and system memory, as discussed in greater detail below. Embodiments within the scope disclosed herein also include physical and other computer-readable media for carrying or storing computer-executable instructions and/or data structures. In particular, one or more of the processes described herein may be implemented at least in part as instructions embodied in a non-transitory computer-readable medium and executable by one or more computing devices (e.g., any of the media content access devices described herein). In general, a processor (e.g., a microprocessor) receives instructions, from a non-transitory computer-readable medium, (e.g., a memory, etc.), and executes those instructions, thereby performing one or more processes, including one or more of the processes described herein.

Computer-readable media can be any available media that can be accessed by a general purpose or special purpose computer system. Computer-readable media that store computer-executable instructions are non-transitory computer-readable storage media (devices). Computer-readable media that carry computer-executable instructions are transmission media. Thus, by way of example, and not limitation, embodiments of the invention can comprise at least two distinctly different kinds of computer-readable media: non-transitory computer-readable storage media (devices) and transmission media.

Non-transitory computer-readable storage media (devices) includes RAM, ROM, EEPROM, CD-ROM, solid state drives (“SSDs”) (e.g., based on RAM), Flash memory, phase-change memory (“PCM”), other types of memory, other optical disk storage, magnetic disk storage or other magnetic storage devices, or any other medium which can be used to store desired program code means in the form of computer-executable instructions or data structures and which can be accessed by a general purpose or special purpose computer.

A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmissions media can include a network and/or data links which can be used to carry desired program code means in the form of computer-executable instructions or data structures and which can be accessed by a general purpose or special purpose computer. Combinations of the above should also be included within the scope of computer-readable media.

Further, upon reaching various computer system components, program code means in the form of computer-executable instructions or data structures can be transferred automatically from transmission media to non-transitory computer-readable storage media (devices) (or vice versa). For example, computer-executable instructions or data structures received over a network or data link can be buffered in RAM within a network interface module (e.g., a “NIC”), and then eventually transferred to computer system RAM and/or to less volatile computer storage media (devices) at a computer system. Thus, it should be understood that non-transitory computer-readable storage media (devices) can be included in computer system components that also (or even primarily) utilize transmission media.

Computer-executable instructions comprise, for example, instructions and data which, when executed at a processor, cause a general purpose computer, special purpose computer, or special purpose processing device to perform a certain function or group of functions. In some embodiments, computer-executable instructions are executed on a general purpose computer to turn the general purpose computer into a special purpose computer implementing elements of the invention. The computer executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the invention may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, tablets, pagers, routers, switches, and the like. The invention may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

Embodiments of the invention can also be implemented in cloud computing environments. In this description, “cloud computing” is defined as a model for enabling on-demand network access to a shared pool of configurable computing resources. For example, cloud computing can be employed in the marketplace to offer ubiquitous and convenient on-demand access to the shared pool of configurable computing resources. The shared pool of configurable computing resources can be rapidly provisioned via virtualization and released with low management effort or service provider interaction, and then scaled accordingly.

A cloud-computing model can be composed of various characteristics such as, for example, on-demand self-service, broad network access, resource pooling, rapid elasticity, measured service, and so forth. A cloud-computing model can also expose various service models, such as, for example, Software as a Service (“SaaS”), Platform as a Service (“PaaS”), and Infrastructure as a Service (“IaaS”). A cloud-computing model can also be deployed using different deployment models such as private cloud, community cloud, public cloud, hybrid cloud, and so forth. In this description and in the claims, a “cloud-computing environment” is an environment in which cloud computing is employed.

As illustrated in FIG. 9, the IP/packet network 952 may also include network devices 902 devices and datacenters 904. The network devices 902 devices and datacenters 904 illustrated in FIG. 9 may be exemplary configurations of the network device 202 and datacenters 204 described above. For example, example of network devices 902 include a variety of devices, such as personal computers, a tablet computer, handheld devices, mobile phones, smartphones, a personal digital assistants (“PDA”), in- or out-of-car navigation systems, and other electronic access devices. In addition, the network device 902 may be part of an enterprise environment, such as a professional business exchange (“PBX”), a small office/home office environment, or a home/personal environment.

As briefly described above, network devices 902 may include dedicated devices and soft devices. Dedicated devices are commonly designed and appear like a digital business telephone. Soft devices or softphones refer to software installed on a computing device. This software utilizes microphone, audio, and/or video capabilities of the computing device and provides traditional calling functionality to a user, operated via a user interface.

Datacenter 904 may facilitate communications between network devices 902. For example, datacenter 904 registers devices, stores device identification and address information, tracks current communications, and logs past communications, etc., as described above. In addition, datacenters 904 also assists network devices in provisioning, signaling, and establishing user communications via a media bridge.

In the case of multiple datacenters 904, one datacenter 904 may communicate with another datacenter 904. For example, one datacenter 904 may send gathered network device 902 information to the other datacenter 904. In particular, when a datacenter 904 registers a network device 902, that datacenter 904 may send the address information to the other datacenters 904 located on the IP/packet network 952. Accordingly, each datacenter 904 may communicate with others datacenters 904 and assist the IP/packet network 952 in balancing network and processing loads. Further, the datacenters 904 may assist the IP/packet network 952 to ensure that communication sessions between network devices 902 do not fail by communicating with each other.

As illustrated, the network devices 902 and the datacenters 904 may be connected to the IP/packet network 952 via switches 960a-b. Switches 960a-b manage the flow of data across the IP/packet network 952 by transmitting a received message to the device for which the message was intended. In some configurations, the switches 960a-b may also perform router functions. Further, while not illustrated, one or more modems may be in electronic communication with the switches 960a-b.

In addition, the IP/packet network 952 may facilitate session control and signaling protocols to control the signaling, set-up, and teardown of communication sessions. In particular, the IP/packet network 952 may employ SIP signaling. For example, the IP/packet network 952 may include a SIP server that processes and directs signaling between the network devices 902 and the IP/packet network 952. Other protocols may also be employed. For example, the IP/packet network 952 may adhere to protocols found in the H.225, H.323, and/or H.245 standards, as published by the International Telecommunications Union, available at the following URL—http://www.itu.int/publications.

In particular, session initiation protocol (“SIP”) is a standard proposed by the Internet Engineering Task Force (“EITF”) for establishing, modifying, and terminating multimedia IP sessions. Specifically, SIP is a client/server protocol in which clients issue requests and servers answer with responses. Currently, SIP defines requests or methods, including INVITE, ACK, OPTIONS, REGISTER, CANCEL, and BYE.

The INVITE request is used to ask for the presence of a contacted party in a multimedia session. The ACK method is sent to acknowledge a new connection. The OPTIONS request is used to get information about the capabilities of the server. In response to an OPTIONS request, the server returns the methods that it supports. The REGISTER method informs a server about the current location of the user. The CANCEL method terminates parallel searches. The client sends a BYE method to leave a session. For example, for a communication session between two network devices 902, the BYE method terminates the communication session.

Once signaling is established, the IP/packet network 952 may establish a media bridge. The media bridge caries the payload data for a communication session. The media bridge is separate for the device signaling. For example, in a videoconference, the media bride includes audio and video data for a communication session.

As described above a datacenter 904 may facilitate a media bridge path for a network device 902. For example, when one network device 902 attempts the contact a second network device 902, the datacenter 904 may execute the signaling and also determine a media bridge between the two network devices 902. Further, the datacenter 904 may provide alternative media bridge paths to the network devices 902 in the event that the primary media bridge weakens, for example, below a threshold level, or even fails.

In the foregoing specification, the invention has been described with reference to specific exemplary embodiments thereof. Various embodiments and aspects of the invention(s) are described with reference to details discussed herein, and the accompanying drawings illustrate the various embodiments. The description above and drawings are illustrative of the invention and are not to be construed as limiting the invention. Numerous specific details are described to provide a thorough understanding of various embodiments disclosed herein.

The present invention may be embodied in other specific forms without departing from its spirit or essential characteristics. The described embodiments are to be considered in all respects only as illustrative and not restrictive. For example, the methods described herein may be performed with less or more steps/acts or the steps/acts may be performed in differing orders. Additionally, the steps/acts described herein may be repeated or performed in parallel with one another or in parallel with different instances of the same or similar steps/acts. The scope of the invention is, therefore, indicated by the appended claims rather than by the foregoing description. All changes that come within the meaning and range of equivalency of the claims are to be embraced within their scope.

What is claimed is:

1. A method for communication, comprising:
establishing a first connection between a network device and a first datacenter of a plurality of datacenters;
determining, using at least one processor, a plurality of connectivity metrics that corresponds to each of the plurality of datacenters; and
switching from the first connection to a second connection between the network device and a second datacenter of the plurality of datacenters when a connectivity metric that corresponds to the second datacenter is superior to a connectivity metric that corresponds to the first datacenter.

2. The method of claim 1, wherein the network device is a voice-over internet protocol device.

3. The method of claim 1, wherein establishing the first connection between the network device and the first datacenter comprises session initiation protocol signaling between the network device and the first datacenter.

4. The method of claim 1, wherein switching to the second connection comprises terminating the first connection between the network device and the first datacenter.

5. The method of claim 1, wherein the connectivity metric corresponding to the second datacenter is superior to the connectivity metric corresponding to the first datacenter further comprises when the connectivity metric between the network device and the second datacenter exceeds the connectivity metric between the network device and the first datacenter by a threshold value.

6. The method of claim 1, further comprising reestablishing the first connection between the network device and the first datacenter when the connectivity metric corresponding to the first datacenter is superior to the connectivity metric corresponding to the second datacenter.

7. The method of claim 1, wherein determining the connectivity metric of each of the plurality of datacenters comprises monitoring at least one of quality of the network connections, response times, communication path reliability, network traffic metrics, geographic proximity, number of hops, and previous paths employed.

8. The method of claim 1, wherein establishing the connection between the network device and the first datacenter comprises the first datacenter assigning an address to the network device.

9. The method of claim 8, wherein establishing the first connection between the network device and the first datacenter is based on the connectivity metric corresponding to the first datacenter being superior to any other connectivity metric.

10. A method for communication on a voice-over internet protocol network, comprising:
analyzing, using at least one processor, a first connection between a voice-over internet protocol device and a first datacenter to obtain a first connectivity metric;
analyzing an available connection between the voice-over internet protocol device and a second datacenter to obtain a second connectivity metric;
determining that the second connectivity metric is superior to the first connectivity metric;
based on the second connectivity metric being superior to the first connectivity metric, establishing a second connection between the voice-over internet protocol device and the second datacenter; and
terminating the first connection between the voice-over internet protocol device and the first datacenter upon establishing the second connection between the voice-over internet protocol device and the second datacenter.

11. The method of claim 10, wherein determining that the second connectivity metric is superior to the first connectivity metric comprises determining that the second connectivity metric is superior to the first connectivity metric based on at least one of quality of the network connections, response times, communication path reliability, network traffic metrics, geographic proximity, number of hops, and previous paths employed.

12. The method of claim 10, wherein establishing the second connection between the voice-over internet protocol device and the second datacenter, and terminating the first connection between the voice-over internet protocol device and the first datacenter occur without detection from a user.

13. A system for voice-over internet protocol communication, comprising:
at least one processor; and
at least one non-transitory computer readable storage medium storing instructions thereon that, when executed by the at least one processor, cause the system to:
receive data from one or more network devices connected to a first datacenter;
analyze the data received from the one or more network devices to determine network characteristic information;
identify a network device having one or more attributes related to the one or more network devices; and
send the network characteristic information to the identified network device based on the analyzed data.

14. The system of claim 13, wherein the network characteristic information instructs the identified network device to establish a connection with a second datacenter.

15. The system of claim 13, wherein the data received from the one or more network devices include a connectivity metric between each of the one or more network devices and the first datacenter.

16. The system of claim 13, wherein the data received from the one or more network devices indicate that the connection between the one or more network devices and the first datacenter has weakened below a threshold value.

17. The system of claim 13, wherein the one or more network devices are located within a geographic proximity of one another, and wherein the network device is within the geographic proximity of the one or more network devices.

18. The system of claim 13, wherein the attribute is one of network proximity, geographic proximity, address proximity, and routing proximity.

19. The system of claim 13, wherein the network device is included in the one or more network devices.

20. The system of claim 18, wherein the network device is not included in the one or more network devices.
